(19) United States
(12) Patent Application Publication
(10) Pub. No.: US 2026/0134522 A1
(43) Pub. Date: May 14, 2026

(54) VIDEO PROCESSING METHOD, ELECTRONIC DEVICE FOR VIDEO PROCESSING, AND STORAGE MEDIUM

(71) Applicant: SAMSUNG ELECTRONICS CO., LTD., Suwon-si (KR)

(72) Inventors: Fan WANG, Beijing (CN); Ying ZHANG, Beijing (CN); Zikun LIU, Beijing (CN); Jia LI, Beijing (CN); Jianxing ZHANG, Beijing (CN); Hyunhee PARK, Suwon-si (KR)

(73) Assignee: SAMSUNG ELECTRONICS CO., LTD., Suwon-si (KR)

(21) Appl. No.: 19/219,647

(22) Filed: May 27, 2025

Related U.S. Application Data
(63) Continuation of application No. PCT/KR2025/004868, filed on Apr. 10, 2025.

(30) Foreign Application Priority Data
Nov. 12, 2024 (CN) 202411611776.7

(51) Int. Cl. G06T 5/73; G06T 5/50; G06T 5/60; G06T 5/70; G06T 7/246; H04N 23/68; H04N 23/71; H04N 23/73

(52) U.S. Cl. CPC G06T 5/73; G06T 5/50; G06T 5/60; G06T 5/70; G06T 7/248; G06T 2207/10016; G06T 2207/10144; G06T 2207/20084; G06T 2207/20201; G06T 2207/20221; G06T 2207/30241; H04N 23/683; H04N 23/684; H04N 23/71; H04N 23/73

(57) ABSTRACT

According to an embodiment of the disclosure, a method of processing a video, the method being performed by an electronic device may be provided. The method may include determining a first motion trajectory of pixels between at least two first images of the video. The method may include determining motion trajectory points corresponding to at least one second image of the video based on the first motion trajectory. The method may include obtaining a second motion trajectory based on the motion trajectory points, a blurriness of the at least one second image being greater than a blurriness of each of the at least two first images. The method may include performing a deblurring processing on the at least one second image based on the second motion trajectory.

### CROSS-REFERENCE TO RELATED APPLICATIONS

This application is a continuation of International Application No. PCT/KR2025/004868, filed on Apr. 10, 2025, which is based on and claims priority to Chinese Patent Application No. 202411611776.7, filed on Nov. 12, 2024, in the China National Intellectual Property Administration, the disclosures of which are incorporated by reference herein in their entireties.

### BACKGROUND

### 1. Field

One or more example embodiments of the disclosure relate to video processing, and in particular, relate to a method of processing a video performed by an electronic device, the electronic device and, a storage medium to perform video processing.

### 2. Description of Related Art

With an improvement of hardware such as sensors and lenses, video quality of cameras of electronic devices increases, while user's requirements for the video quality of electronic devices increase. However, situations like shaking of the electronic device held by a shooter, a movement of a shot object, etc. will lead to motion blur of ta recorded video, which seriously affects user experience.

Currently, related art methods to solve motion blur in a video attempt to use improvements in hardware. For example, an image stabilization sensor is used to capture a smooth and stable video by compensating for noticeable vibration and motion. However, this approach relies on expensive hardware costs and remains less effective for shooting of a motion scene.

### SUMMARY

According to an embodiment of the disclosure, a method of processing a video, the method being performed by an electronic device may be provided. The method may include determining a first motion trajectory of pixels between at least two first images of the video. The method may include determining motion trajectory points corresponding to at least one second image of the video based on the first motion trajectory. The method may include obtaining a second motion trajectory based on the motion trajectory points, a blurriness of the at least one second image being greater than a blurriness of each of the at least two first images. The method may include performing a deblurring processing on the at least one second image based on the second motion trajectory.

According to an embodiment of the disclosure, an electronic device may be provided. The electronic device may include at least one processor including processing circuitry, and memory comprising one or more storage media storing instructions that, when executed by the at least one processor individually or collectively. The instructions when executed by the at least one processor individually or collectively, cause the electronic device to determine a first motion trajectory of pixels between at least two first images of a video. The instructions when executed by the at least one processor individually or collectively, cause the electronic device to determine motion trajectory points corresponding to at least one second image of the video based on the first motion trajectory. The instructions when executed by the at least one processor individually or collectively, cause the electronic device to obtain a second motion trajectory based on the motion trajectory points, a blurriness of the at least one second image being greater than a blurriness of each of the at least two first images. The instructions when executed by the at least one processor individually or collectively, cause the electronic device to perform a deblurring processing on the at least one second image based on the second motion trajectory.

According to an embodiment of the disclosure, a non-transitory computer-readable medium storing one or more instructions may be provided. The one or more instructions, when executed by at least one processor, may cause the at least one processor of an electronic device to perform operation corresponding to the method.

### BRIEF DESCRIPTION OF THE DRAWINGS

In order to more clearly explain the technical solutions in the example embodiments of the present disclosure, the accompanying drawings to be used in the description of the embodiments of the present disclosure will be briefly described below, in which:

FIG. 1 is a schematic flowchart of a method performed by an electronic device according to an embodiment of the present disclosure;

FIG. 2 is a schematic diagram of a process of capture determination according to an embodiment of the present disclosure;

FIG. 3 is a schematic diagram of a process of exposure parameter prediction according to an embodiment of the present disclosure;

FIG. 4 is a schematic diagram of a sharp frame capture method according to an embodiment of the present disclosure;

FIG. 5 is a schematic diagram of optimal exposure time according to an embodiment of the present disclosure;

FIG. 6 is a schematic diagram of a method for setting a second threshold according to an embodiment of the present disclosure;

FIG. 7 is a schematic diagram of motion segments and clips of a video according to an embodiment of the present disclosure;

FIG. 8 is a schematic diagram of a fitted motion trajectory according to an embodiment of the present disclosure;

FIG. 9 is a schematic diagram of a sharp frame trajectory modeling method according to an embodiment of the present disclosure;

FIG. 10a is a schematic diagram of a motion trajectory point adjustment according to an embodiment of the present disclosure;

FIG. 10b is a schematic diagram of another motion trajectory point adjustment according to an embodiment of the present disclosure;

FIG. 10c is a schematic diagram of yet another motion trajectory point adjustment according to an embodiment of the present disclosure;

FIG. 11 is a schematic diagram of a blur frame trajectory point localization method according to an embodiment of the present disclosure;

FIG. 12a is a schematic diagram of a scale-down situation according to an embodiment of the present disclosure;

FIG. 12b is a schematic diagram of a scale-up situation according to an embodiment of the present disclosure;

FIG. 13 is a schematic diagram of an inter-frame relation extraction method according to an embodiment of the present disclosure;

FIG. 14 is a schematic diagram of a blur frame trajectory localization method according to an embodiment of the present disclosure;

FIG. 15 is a schematic diagram of a Fourier-guided texture interaction according to an embodiment of the present disclosure;

FIG. 16a is a schematic diagram of a pixel clustering method according to an embodiment of the present disclosure;

FIG. 16b is a schematic diagram of a self-attention window according to an embodiment of the present disclosure;

FIG. 16c is a schematic diagram of another self-attention window according to an embodiment of the present disclosure;

FIG. 16d is a schematic diagram of yet another self-attention window according to an embodiment of the present disclosure;

FIG. 16e is a schematic diagram of a motion information based self-attention window according to an embodiment of the present disclosure;

FIG. 17 is a schematic diagram of a scale deformation method according to an embodiment of the present disclosure;

FIG. 18 is a schematic diagram of a motion-guided inter-frame attention according to an embodiment of the present disclosure;

FIG. 19 is a schematic diagram of a video deformation according to an embodiment of the present disclosure;

FIG. 20 is a schematic diagram of an inter-clip attention according to an embodiment of the present disclosure;

FIG. 21 is a schematic diagram of a deblurring processing method according to an embodiment of the present disclosure;

FIG. 22 is a schematic diagram of a Fourier-guided luminance interaction according to an embodiment of the present disclosure;

FIG. 23 is a schematic diagram of a Fourier-guided interaction manner according to an embodiment of the present disclosure;

FIG. 24 is a schematic diagram of a dual-branch interaction diffusion model according to an embodiment of the present disclosure;

FIG. 25 is a schematic diagram of processing a plurality of video clips according to an embodiment of the present disclosure;

FIG. 26 is a schematic diagram of a complete scheme for video deblurring according to an embodiment of the present disclosure;

FIG. 27 is a schematic flowchart of another method performed by an electronic device according to an embodiment of the present disclosure;

FIG. 28 is a schematic flowchart of yet another method performed by an electronic device according to an embodiment of the present disclosure; and

FIG. 29 is a schematic diagram of a structure of an electronic device according to an embodiment of the present disclosure.

### DETAILED DESCRIPTION

The following description with reference to the accompanying drawings is provided to assist in a comprehensive understanding of various example embodiments of the present disclosure as defined by the claims and their equivalents. The following description includes various specific details to assist in that understanding but these are to be regarded as merely examples. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces. When an element is referred to as being “connected” or “coupled” to another element, the element may be directly connected or coupled to the other element, or it may also mean that a connection relationship between the element and the other element is established through intervening elements. In addition, the word “connected” or “coupled” as used herein may include wirelessly connected or coupled.

The term “include” or “may include” may refer to the existence of a corresponding disclosed function, operation or component which may be used in various embodiments of the present disclosure and does not limit one or more additional functions, operations, or components. The terms such as “include” or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B. When describing a plurality (two or more) of items, the plurality of items may refer to one, more, or all of them if the relationship between the plurality of items is not explicitly defined. For example, the description of “parameter A including A1, A2, A3” may be realized as parameter A including A1 or A2 or A3, and may also be realized as parameter A including at least two of these three items A1, A2, A3.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

At least some of functions in an apparatus or an electronic device according to an embodiment of the present disclosure may be realized by an AI model. For example, at least one of a plurality of modules of the apparatus or the electronic device may be realized by the AI model. The functions associated with the AI may be performed by a non-volatile memory, a volatile memory, and a processor.

The processor may include one or more processors. At this point, the one or more processors may be general-purpose processors, such as central processing units (CPUs), application processors (APs), etc., or pure graphics processing units, such as graphics processing units (GPUs), vision processing units (VPUs), and/or AI-specific processors, for example, neural processing units (NPUs).

The one or more processors control processing of input data based on predefined operating rules or artificial intelligence (AI) models stored in the non-volatile memory and the volatile memory. The predefined operating rules or AI models are provided through training or learning.

Here, provided by learning may refer to obtaining the predefined operating rules or the AI models with desired characteristics by applying a learning algorithm to a plurality of learning data. The learning may be performed in the apparatus or electronic device itself in which the AI according to embodiments is executed, and/or may be realized by a separate server/system.

The AI model may contain a plurality of neural network layers. Each layer has a plurality of weight values, and each layer performs a neural network computation by a computation between the input data of that layer (e.g., the computation results of a previous layer and/or the input data of the AI model) and the plurality of weight values of the current layer. Examples of neural networks include, but are not limited to, convolutional neural networks (CNNs), deep neural networks (DNNs), recurrent neural networks (RNNs), Restricted Boltzmann Machines (RBMs), Deep Belief Networks (DBNs), Bi-directional Recurrent Deep Neural Networks (BRDNNs), Generative Adversarial Networks (GANs), and deep Q-networks.

The learning algorithm is a method of training a predetermined target apparatus (e.g., a robot) using the plurality of learning data to enable, allow, or control the target apparatus to make determinations or predictions. Examples of the learning algorithm include, but are not limited to, supervised learning, unsupervised learning, semi-supervised learning, or reinforcement learning.

The methods provided in the present disclosure may relate to one or more of the technical fields of speech, language, image, video, or data intelligence and the like.

Optionally, when relating to the field of speech or language, in the method performed by the electronic device according to the present disclosure, a method for recognizing a user's speech and interpreting a user's intent may be performed by receiving a speech signal as an analog signal via a speech capture apparatus (e.g., a microphone) of the electronic device and converting the speech portion into computer-readable text using an automatic speech recognition (ASR) model. The intent of user's utterances may be obtained by interpreting the converted text using a natural language understanding (NLU) model. The ASR model or NLU model may be an artificial intelligence model. The artificial intelligence model may be processed by an artificial intelligence-specific processor designed in a hardware architecture specified for artificial intelligence model processing. The artificial intelligence model may be obtained by training. Here, “obtained by training” means training a basic AI model with a plurality of training data by a training algorithm to obtain a predefined operating rule or AI model configured to perform a desired feature (or purpose). Language understanding is a technique for recognizing and applying/processing human language/text, including, for example, natural language processing, machine translation, dialog systems, question and answer, or speech recognition/synthesis.

Optionally, when relating to the field of image or video, in the method performed by the electronic device according to the present disclosure, a method for video deblurring may obtain output data of recognizing an image or trajectories, blur maps, image features, etc., in the image by using image data as input data to the artificial intelligence model. The artificial intelligence model may be obtained by training. Here, “obtained by training” means training a basic AI model with a plurality of training data by a training algorithm to obtain a predefined operating rule or AI model configured to perform a desired feature (or purpose). The methods of the present disclosure may relate to the field of artificial intelligence techniques for visual understanding, which is a technique for recognizing and processing things like human vision, and may include, for example, object recognition, object tracking, image retrieval, human identification, scene recognition, 3D reconstruction/localization, or image enhancement.

Optionally, when relating to the field of intelligent processing of data, in the method performed by the electronic device according to the present disclosure, a method for inferring or predicting motion description information may be recommended/performed using an artificial intelligence model through the use of motion trajectory data. A processor of the electronic device may perform preprocessing operations on the data to convert it into a form suitable for use as input to the artificial intelligence model. The artificial intelligence model may be obtained by training. Here, “obtained by training” means training a basic AI model with a plurality of training data by a training algorithm to obtain a predefined operating rule or AI model configured to perform a desired feature (or purpose). Inferential prediction is a technique for performing logical inference and prediction by determining information, including, for example, knowledge-based reasoning, optimized prediction, preference-based planning, or recommendation.

In order to make the objects, technical solutions, and advantages of the present disclosure clearer, the embodiments of the present disclosure will be described in further detail below in conjunction with the accompanying drawings.

One or more example embodiments of the present disclosure solve a problem of how to improve a video deblurring effect for a motion scene.

When shooting a motion scene, either the movement of an object or the movement of an electronic device used for shooting will result in a blur phenomenon in the shot video, and the blur is generally very serious, especially when the scene is a high-speed motion one. However, existing video deblurring methods are less effective in the motion scene. For example, severe blur caused by high-speed motion weakens the similarity between a blurred region and a target object, thereby leading to the inability to find similar features or to find them correctly, which results in poor performance, thus leading to the inability of existing methods to accurately handle the high-speed motion scene.

The method performed by the electronic device, the electronic device, the storage medium and the program product according to the present disclosure may also be referred to as a video deblurring scheme, which is intended to address at least one of the technical problems in the relevant art as described above.

Next, the technical solutions of the embodiments of the present disclosure and the technical effects produced by the e technical solution of the embodiments of the present disclosure will be described by describing several example implementations. It should be noted that the following implementations may be referred to, learned from, or combined with each other, and the same terms, similar features, and similar implementation steps in different implementations will not be described repeatedly.

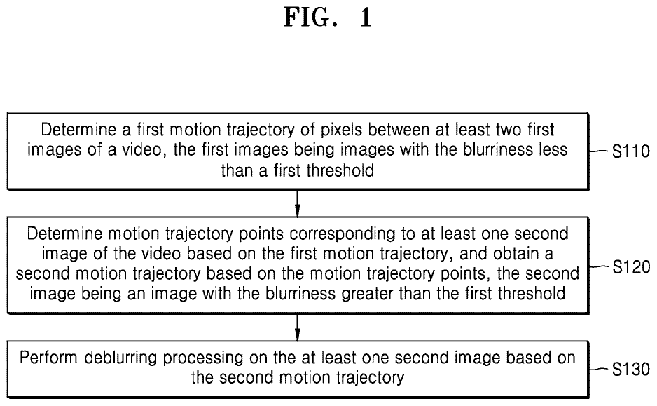

An embodiment of the present disclosure provides a method performed by an electronic device. FIG. 1 is a schematic flowchart of a method performed by an electronic device according to an embodiment of the present disclosure. As shown in FIG. 1, the method may include steps S110-S130.

At step S110, a first motion trajectory of pixels between at least two first images of a video may be determined.

In the embodiment of the present disclosure, the video may be recorded by a user in real time, selected by the user in a photo album, or received by the user from a network or other device, etc., and the embodiment of the present disclosure does not limit how the video is acquired.

In the embodiment of the present disclosure, the video may be obtained by directly recording various subjects such as characters, animals, plants, landscapes, buildings, objects, etc., and/or their movement processes, or the video may be obtained by synthesizing a plurality of video data and/or image data, and the embodiment of the present disclosure does not limit a content and a source of the video.

In the embodiment of the present disclosure, the video may include a sequence of consecutive image frames (which may also be referred to as frames, and in an embodiment may also be referred to as frame images or images), and the embodiment of present disclosure does not limit a number of image frames of the video.

In the embodiment of the present disclosure, a shot motion scene may mean that a shot subject is in motion (e.g., shooting a driving vehicle, etc., but not limited thereto), and/or an electronic device used for shooting is in motion (e.g., a shooter is shooting the scene by holding the electronic device in a course of skiing, etc., but not limited thereto), which both may lead to blurring of the shot video. A high-speed motion scene may mean that the subject or the electronic device used for shooting is moving at a faster speed, which may cause greater video blur (which may be referred to as large motion blur), and the high-speed motion scene may be referred to as a large motion scene.

In the embodiment of the present disclosure, the first image may refer to an image in the video with smaller blurriness (which may also be understood as a blur degree), and for ease of understanding, the first image may be referred to as a sharp frame hereinafter. The blurriness of the video or image may be determined based on motion-generated artifact or trailing. For example, the blurriness may be associated with, but not limited to, a number of pixels covered by trailing.

The present disclosure is based on founding, obtained through research and testing, that there are sharp frames inherent in a motion video. Since the sharp frames (or first images) have sharp textures, an accurate first motion trajectory may be predicted between at least two sharp frames, wherein assuming that each image frame of the video includes h*w pixels, then the first motion trajectory of pixels between at least two first images may include h*w first motion trajectories corresponding to the h*w pixels, respectively, and may also include at least one first motion trajectory corresponding to key pixels (e.g., pixels of a target object, etc., but not limited thereto), and the embodiment of the present disclosure is not specifically limited herein.

At step S120, motion trajectory points corresponding to at least one second image of the video may be determined based on the first motion trajectory, a second motion trajectory may be obtained based on the motion trajectory points, wherein the blurriness of the second image is greater than the blurriness of the first images.

In the embodiment of the present disclosure, the second image may refer to an image in the video with a greater blurriness, and for ease of understanding, the second image may be referred to as a blur frame hereinafter. In one example, the first image is an image with the blurriness smaller than a first threshold, and the second image is an image with the blurriness greater than the first threshold, where a criterion (e.g., the first threshold) used to determine the sharp frames and the blur frames may be set by those skilled in the art in accordance with an actual implementation, and the embodiment of the present disclosure is not limited herein.

Considering that a video with a large motion cannot predict an accurate motion trajectory based on the second image itself, in the embodiment of the present disclosure, more accurate motion trajectory points may be set for the second image based on the first motion trajectory of the sharp frames. The motion trajectory points may be understood as corresponding to motion states of the blur frames that are localized in the at least one established first motion trajectory. Accordingly, a second motion trajectory may be obtained based on localized motion trajectory points corresponding to the second image.

At step S130, deblurring processing may be performed on the at least one second image based on the second motion trajectory.

In the embodiment of the present disclosure, this step may be performed by using an artificial intelligence (AI) model (such as a deblurring model), and those skilled in the art may set a type, a structure, and/or a training method of the adopted AI network according to an actual implementation. For example, the AI network may include a diffusion network, an attention network, etc., or may be other neural network models, and the embodiment of the present disclosure is not limited herein.

In the embodiment of the present disclosure, an inter-frame trajectory relation in the second motion trajectory may be used as guidance information of the deblurring model to remove motion blur in the video and obtain a video with clear textures, which, in particular, may solve the motion blur of the large motion scene.

The video deblurring method provided in the embodiment of the present disclosure may set more accurate motion trajectory points for the second image based on the first motion trajectory, may overcome the problem that the video cannot predict an accurate motion trajectory based on the second image itself in a motion scene, and may guarantee a better video deblurring effect in the motion scene based on the second motion trajectory.

In an optional implementation, the at least two first images described above may be detected in the shot video, for example, the sharp frames in the video are detected by a detection module.

In an implementation, considering that a proportion of the sharp frames in a real video in the high-speed motion scene may be low, for example, generally 0˜1%, in order to improve an effect of utilizing the sharp frames, an embodiment of the present disclosure provides a method of actively capturing the sharp frames. Optionally, short exposure frames (e.g., sharp frames) may be actively captured by a sharp frame capture module.

Specifically, in the process of acquiring the video, in a case where a blurriness of a third image currently acquired based on a first exposure parameter is detected to be greater than a threshold (e.g., second threshold), at least one image after the third image may be acquired based on a second exposure parameter, and the image acquired based on the second exposure parameter may be used as the first image, wherein exposure time corresponding to the second exposure parameter is less than exposure time corresponding to the first exposure parameter.

According to an embodiment of the disclosure, the third image may be an image frame of the video, for determining parameters of capturing the video. For example, the third image may be an image obtained based on the first exposure parameter. The electronic device may analyze the blurriness of the third image. According to an embodiment of the disclosure, the electronic device may determine the third image as the first image or the second image. According to an embodiment of the disclosure, the electronic device may adjust the exposure parameter to be used in the process of acquiring an image located after the third image in a sequential sequence. The electronic device may obtain at least one image after the third image as the first image.

Optionally, the exposure parameter may include the exposure time or the like, but is not limited thereto.

Optionally, the blurriness of the third image may be determined based on a blur map of the third image. Optionally, a blur estimation network may be pre-trained to compute the blur map of the third image. For example, features of the third image may be extracted using a convolutional layer to obtain convolutional features thereof. By using the convolutional layer to further extract features about the blur for the obtained convolutional features, the blur map of the third image in an X-axis and a Y-axis may be predicted, wherein the blur map represents the blurriness (value) and direction (positive or negative, which may for example correspond to an inverse direction of trailing) of each pixel in the third image.

Motion blur in a video may be generally due to long exposure time when being shot. Therefore, short exposure frames, e.g., sharp pictures captured with shorter exposure time, may be actively captured as the sharp frames. Since the short exposure frames have clear textures, the short exposure frames may be used to eliminate large motion blur in the video.

In the embodiments of the present disclosure, the shooting of the video and the capturing of the short exposure frames may be performed using a same acquisition device (e.g., a video camera), and thus the short exposure frames may be a part of a video sequence, and shooting the short exposure frames may not change a frame rate of the video.

In the embodiment of the present disclosure, the first exposure parameter may be an auto-exposure parameter computed by the electronic device.

Optionally, it is determined, by a capture determination module in the process of acquiring the video, that whether there is blur in the current frame (shot based on the first exposure parameter), and if a blur value of the current frame exceeds a set blur threshold (the second threshold), the second exposure parameter may be used to shoot the short exposure frames (the sharp frames) with the clear textures using shorter shooting exposure time.

Optionally, a number of images acquired based on the second exposure parameter may be set by those skilled in the art according to an actual implementation, such as one frame, etc., and the embodiment of the present disclosure is not limited herein.

Optionally, each of the third images may be treated as a second image (blur frame) for subsequent processing. Optionally, images other than the third image and the short exposure frames may be processed directly as the second image, or may be processed in a corresponding manner after the determination of the blur frames or the sharp frames.

Optionally, the above-described second threshold may be the same as the above-described first threshold. Alternatively, the above-described second threshold may be different from the above-described first threshold, for example, the first threshold is less than the second threshold.

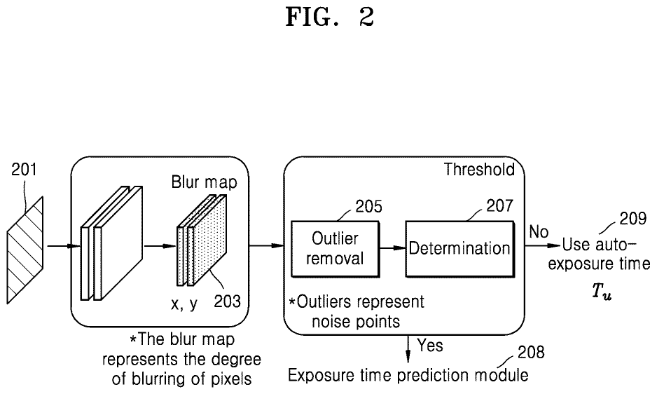

In one example, a process of the capture determination module (determining whether or not the short exposure frames need to be captured based on the blur degree of the current frame) may be as shown in FIG. 2. FIG. 2 is a schematic diagram of a process of capture determination according to an embodiment of the present disclosure. Optionally, the following process may be started when the shooter triggers corresponding function upon shooting a video by the electronic device: obtaining a current frame image 201 to be processed; computing a blur map 203 of the current frame 201 in the X-axis and the Y-axis (indicating the blur degree of the pixels) by an estimation network; and removing outliers 205 (e.g., indicating noise points, such as outlying values and small cluster regions, etc.) in the blur map 203, in order to avoid these points from affecting subsequent threshold determination. The values (e.g., absolute values) of the blur map 203 may be compared with the set threshold (e.g., the second threshold) to determine 207 whether to actively capture the sharp frames (e.g., the short exposure frames). If it is determined that the sharp frames are to be actively captured, an exposure time prediction module 208 may be used, otherwise, the auto-exposure time 209 computed by the electronic device may be used. For example, in a case where the value of the blur map 203 of the current frame 201 is greater than or equal to the second threshold, it is determined that the sharp frames are to be actively captured; and in a case where the value of the blur map 203 of the current frame 201 is smaller than the second threshold, it is determined that the sharp frames are not to be actively captured, and the auto-exposure time 208 computed by the electronic device may be used.

In an optional implementation, the second exposure parameter may be a preset fixed value, those skilled in the art may set the value of the second exposure parameter according to an actual implementation, and the embodiment of the present disclosure is not limited herein.

In an optional implementation, the second exposure parameter may be computed in real time. Optionally, for example, before the at least one image after the third image is acquired based on the second exposure parameter, the second exposure parameter may be determined based on the third image and the first exposure parameter. Optionally, the process may be computed by a formula, or may be predicted by a model, or may be determined in other methods, and the embodiment of the present disclosure is not limited herein.

Optionally, the process may be performed by the exposure time prediction module 208, with inputs including first exposure parameter Tᵤ of a current frame (t) and third image-related information, and with outputs including a second exposure parameter Tₚ for shooting the short exposure frames such as a next frame (t+1). The third image-related information may include at least one of the third image, image features of the third image, the blurriness of the third image (e.g., a blur map), and a histogram of the third image, but is not limited thereto.

In the embodiment of the present disclosure, once it is determined to capture the sharp frames, an optional implementation may be provided for predicting the exposure parameters for shooting, where the optimal exposure parameters are required to balance luminance and sharpness. Specifically, the determining the second exposure parameter based on the third image and the first exposure parameter may include:

determining an adjustment coefficient based on the blurriness of the third image and the image features of the third image; and determining the second exposure parameter based on the first exposure parameter and the adjustment coefficient.

In the embodiment of the present disclosure, the blurriness (e.g., blur map) and the image features may be used to optimize the exposure time. Optionally, the blur map 307 of the input frame (or the third image) and its convolutional features 309 (e.g., the image features of the third image) may be used to predict the adjustment coefficient.

Optionally, the blur map 307 of the input frame may characterize the blur degree at a pixel level of the images, where if the blur degree is higher, it indicates that the motion speed is faster, and the optimal exposure time (e.g., the second exposure parameter) needs to be less. The convolutional features 309 of the input frame may characterize richness of image content, where the richer the content is, the more edge information is included, and in a scene including the richer content, the optimal exposure time needs to be shorter. On the contrary, smooth scenes such as a sky, a white wall, etc., have not rich edge information, and the optimal exposure time may be slightly longer.

Optionally, features related to the blur degree (e.g., the blur map 307 of the input frame), and features 309 related to the richness of content of the input frame (e.g., the image features of the input frame) may be used to predict a Ratio 313 value (refer to Equation 1 below) as the adjustment coefficient by using softmax 311.

Optionally, a model or formula may be used to predict the second exposure parameter based on one or more of the-above described parameters.

In the embodiment of the present disclosure, the predicted second exposure parameter may be used to shoot next video frame(s).

In the embodiment of the present disclosure, an optional implementation may be provided for predicting the exposure parameters for shooting. Specifically, the determining the second exposure parameter based on the third image and the first exposure parameter may include the followings.

At step S210, a lower bound (which may also be referred to as a lower limit value, e.g., the shortest exposure time 305) of the exposure time may be determined based on luminance of the third image and the first exposure parameter.

In the embodiment of the present disclosure, luminance of the environment may be determined based on the luminance in the video frames (e.g., at least one third image) that have been shot and the first exposure parameter (e.g., the exposure time), and the greater the luminance of the environment is, the smaller the lower limit value of the exposure time would be, while the lower the luminance of the environment is, the higher the lower limit value of the exposure time would be. This is because longer exposure time is required to capture an image in dark light.

Optionally, histogram 301 statistics may be performed on the current frame (or be referred to as the input frame, the third image) and histogram features may be extracted using a multi-layer perceptron (MLP). Meantime, exposure time features may also be extracted using the MLP for the first exposure parameter. The histogram features and the exposure time features may be concatenated together, and the resulting features may be understood as ambient luminance perception features, for which the MLP is used to predict the lower bound Tₗ 305 of the exposure time.

At step S220, an upper bound of the exposure time (which may also be referred to as an upper limit value, e.g., the longest exposure time 303) may be determined based on the first exposure parameter.

Since the exposure time corresponding to the second exposure parameter may be less than the exposure time corresponding to the first exposure parameter, the exposure time corresponding to the first exposure parameter may be taken as the upper bound of the predicted exposure time.

In the embodiment of the present disclosure, a coarse exposure time adjustment range may be determined based on the upper and lower bounds of the exposure time. For example, the coarse exposure time adjustment range may be denoted as ΔT=Tᵤ−Tₗ, where Tᵤ denotes the upper bound of the exposure time and Tₗ denotes the lower bound of the exposure time. In turn, the exposure time may be further adjusted based on the coarse exposure time adjustment range, with reference to steps S230 and S240.

At step S230, an adjustment coefficient may be determined based on the blurriness of the third image, image features of the third image, the upper bound and the lower bound.

In the embodiment of the present disclosure, the blurriness (e.g., blur map 307) and the image features 309 may be used to optimize the exposure time.

Optionally, in order for the model to determine the exposure time adjustment range, the lower bound Tₗ 305 and the upper bound Tᵤ 303 of the exposure time may be input into the MLP for feature extraction.

Further, the adjustment coefficient may be predicted from features of the predicted coarse exposure time adjustment range (e.g., the upper and lower bounds), the blur map of the input frame (e.g., the third image) and its convolutional features (e.g., the image features of the third image).

Optionally, the blur map 307 of the input frame may characterize the blur degree at a pixel level of the images, where if the blur degree is higher, it is proved that the motion speed is faster, and the optimal exposure time (e.g., the second exposure parameter) is to be less. The convolutional features 309 of the input frame may characterize the richness of image content, where the richer the content is, the more edge information is included, and in this scene, the optimal exposure time is to be shorter. On the contrary, smooth scenes such as a sky, a white wall, etc., do not have rich edge information, and the optimal exposure time may be slightly longer.

Optionally, the features related to the blur degree (e.g., the blur map of the input frame), the features related to the richness of content of the input frame (the image features of the input frame), and the exposure time adjustment range may be concatenated together, to predict a Ratio value 313 (refer to Equation 1 below) as the adjustment coefficient by using softmax 311.

At step S240, the second exposure parameter may be determined based on the first exposure parameter, the upper bound, the lower bound and the adjustment coefficient.

Optionally, the model may be used to predict the second exposure parameter based on these parameters.

Alternatively, optionally, the second exposure parameter Tₚ may be computed using the following Equation:

$${T}_{p} = {T}_{u} - Ratio * Δ T \qquad Equation 1$$

where ΔT=Tᵤ−Tₗ, Tᵤ denotes the upper bound of the exposure time, which also corresponds to the first exposure parameter, Tₗ denotes the lower bound of the exposure time, and Ratio denotes the adjustment coefficient.

In the embodiment of the present disclosure, the predicted second exposure parameter (e.g., the exposure time Tₚ) may be used to shoot next video frame(s).

In the embodiment of the present disclosure, based on the fact that the shorter the exposure time is, the less the motion blur would be, the second exposure parameter prediction process from the determination of the coarse exposure time adjustment range to fine exposure time adjustment may be used instead of directly predicting the optimal exposure time. That is, the shorter the exposure time is, the more it is likely to shoot the sharp frames. If directly making prediction of the optimal exposure time, the model will tend to predict very short exposure time. However, if the exposure time is too short, the captured images will be very dark and may not provide useful information for the blur images, and the short exposure frame may be also a frame in the video sequence. The embodiment of the present disclosure may provide the second exposure parameter prediction process, and thus it is possible to avoid a poor user experience caused by too large difference in the luminance between different frames, or if the luminance of the short-exposure frame needs to be adjusted subsequently, the second exposure parameter prediction process provided in the embodiment of the present disclosure may reduce a difficulty of luminance adjustment.

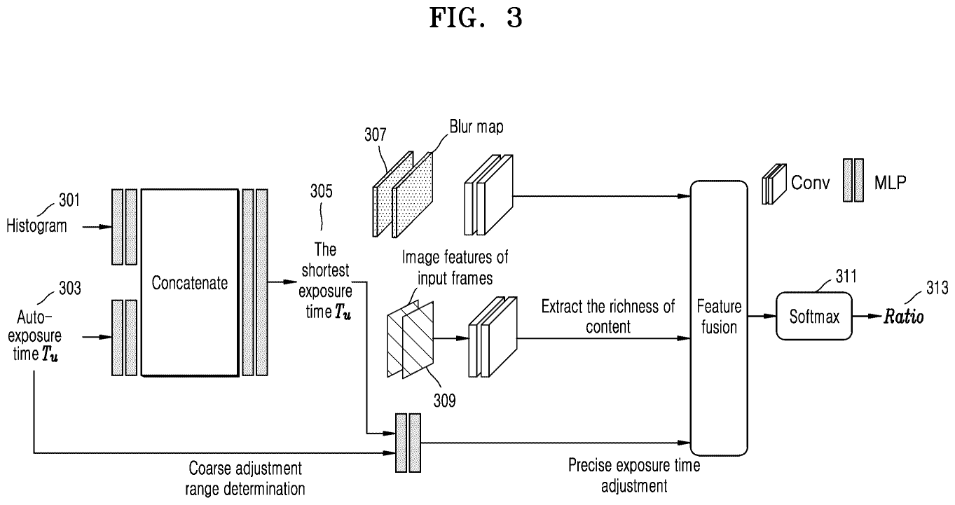

In one example, FIG. 3 illustrates a schematic diagram of a process of the exposure time prediction according to an embodiment of the present disclosure.

Histogram 301 statistics may be performed on the input frames and the MLP may be used to extract histogram features. At the same time, the MLP may be used to extract exposure time features for the auto-exposure time Tᵤ 303 (e.g., the first exposure parameter). The histogram features and the exposure time features may be concatenated together, then the MLP may be used to predict the minimum exposure time Tₗ 305 (e.g., the lower bound of the exposure time), and the auto-exposure time Tᵤ 303 may be used as the upper bound of the exposure time, so as to coarsely determine the exposure time adjustment range.

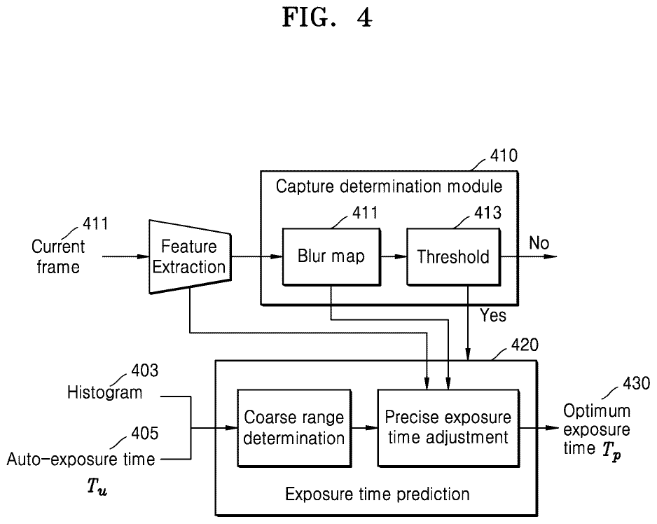

The lower bound Tₗ 305 of the exposure time and the upper bound Tᵤ 303 of the exposure time may be inputted into the MLP for feature extraction, and then the exposure time may be precisely adjusted in conjunction with the blur map 307 of the input frames (which may be a blur map after removing the outliers 205), as well as the image features 309 of the input frames (both of which are subjected to the convolution Conv, to respectively extract the blur degree at a pixel level of the images and the richness of image content). These three features may be concatenated together and softmax 311 may be used to predict a Ratio value 313, such that the optimal exposure time 430 in FIG. 4 (e.g., the second exposure parameter) may be determined based on Tₚ=Tᵤ−Ratio*(Tᵤ−Tₗ) to shoot at least one subsequent video frame.

Based on at least one of the above embodiments, FIG. 4 illustrates a schematic diagram of a method for capturing the sharp frames according to an embodiment of the present disclosure. As shown in FIG. 4, the method may include the followings.

Upon prediction, feature extraction, blur map estimation and histogram statistics may be performed on a current frame 401 (e.g., third image).

A capture determination module 410 may determine whether to shoot the sharp frames (e.g., short exposure frames) at the next moment (t+1) according to the blur degree (e.g., blur map 411) of the current frame (t) in the shot video and a second threshold 413. If it is not required to shoot the sharp frames (e.g., when the blur degree is lower), the first exposure parameter computed by the electronic device (e.g., the auto-exposure time Tᵤ) may be kept unchanged, and the auto-exposure time Tᵤ 405 may be used to capture the next frame. Once it is required to shoot the sharp frames (e.g., the blur degree is higher than a defined second threshold), the exposure time prediction module 420 may be executed to capture the sharp frames (e.g., short exposure frames).

The exposure time prediction module 420 may obtain a coarse exposure time adjustment range ΔT(Tₗ˜Tᵤ) based on histogram 403 of the current frame (t) and the first exposure parameter 405 (e.g., the auto-exposure time Tᵤ).

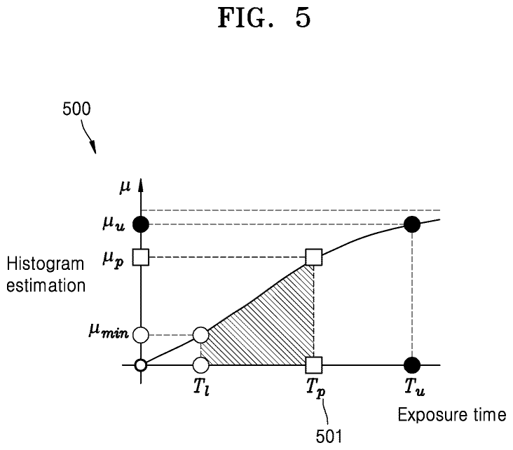

FIG. 5 is a schematic diagram of optimal exposure time according to an embodiment of the present disclosure. As shown in FIG. 5, the optimal exposure time Tₚ 501 of the short-exposure frames may be predicted based on the blur degree and the image features of the current frame within the adjustment range.

The histogram 500 estimates in FIG. 5 may represent the luminance to some extent, and it can be seen that the shorter the exposure time is, the darker the captured images would be, and the optimal exposure time (e.g., the second exposure parameter) Tₚ 501 capable of capturing the sharp frames may be computed by information in the current frame (t), in order to balance luminance differences and ensure the texture clarity.

In the embodiment of the present disclosure, an optional implementation may be provided for setting of the second threshold. Specifically, the second threshold may be preset according to a threshold value at which related art methods (e.g., attention mechanism, similarity or optical flow method, etc.) cannot effectively perform the video deblurring processing.

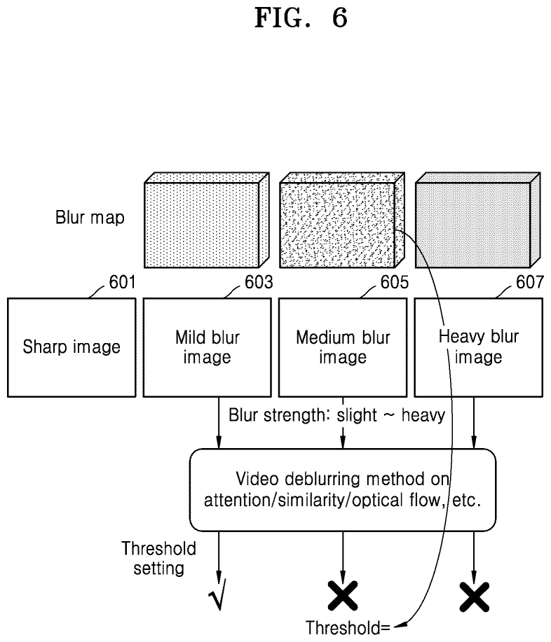

FIG. 6 is a schematic diagram of a method for setting a second threshold according to an embodiment of the present disclosure. For example, as shown in FIG. 6, the blur maps of different blurred images depending on the degree of blur (e.g., sharp 601, mild 603, medium 605, heavy 607, etc., but not limited thereto, and other division criteria may also be used) may be computed and processed using the related art methods. The threshold may be set according to a smallest blur map value that cannot be processed by the related art methods, e.g., the medium blur and the heavy blur cannot be subjected to the video deblurring process using the related art methods, and a smaller blur value corresponding to the medium blur may be used as the second threshold.

In the embodiment of the present disclosure, an optional implementation may be provided for the step S110, and may include the followings.

At step S111, an offset of each of the at least two first images from a predetermined first image may be determined.

Optionally, the offset of each of the at least two first images from the predetermined first image may be determined based on inertial measurement unit (IMU) parameters of an acquisition device when acquiring the video.

Optionally, the IMU parameters may include, but are not limited to, acceleration in three directions of the electronic device provided by an accelerometer (such as [aₓ, a_{y}, a_{z}]), and angular velocities in three directions provided by a gyroscope (such as [gₓ, g_{y}, g_{z}]), and the like.

In the embodiment of the present disclosure, a position of the predetermined first image may be set by those skilled in the art according to the actual demands. For example, the predetermined first image may be a 1st sharp frame (e.g., the 1st first image) in the video, or the predetermined first image may be a last sharp frame (e.g., the last first image) in the video.

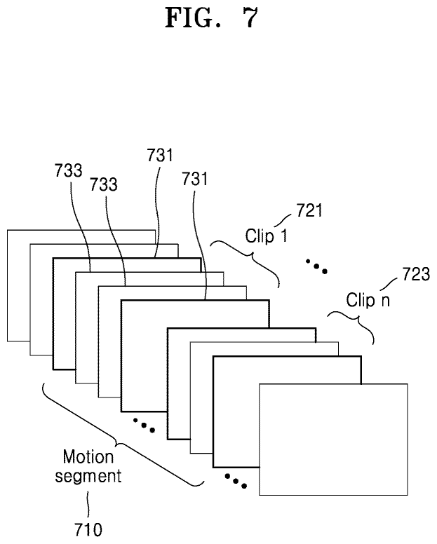

FIG. 7 is a schematic diagram of motion segments and clips of a video according to an embodiment of the present disclosure. For example, as shown in FIG. 7, the captured video may be split into a plurality of motion segments 710, each of which includes a plurality of clips 721, 723 with associated motion trajectories. One clip may include two sharp frames 731 (e.g., the first images) and at least one blur frame 733 (e.g., the second image), and the predetermined first image may be the 1st sharp frame in an associated motion segment, or the predetermined first image may be the 1st sharp frame in an associated clip, and so on, and the embodiment of the present disclosure is not limited herein.

Taking the predetermined first image being the 1st sharp frame as an example, the offset may be roughly computed according to the IMU parameters, and an optical flow model with the IMU parameters of the acquisition device (e.g., the IMU parameters of the camera) may be used as priori information to predict offsets of other sharp frames with respect to the 1st sharp frame, and the priori information may be used to predict optical flows more accurate.

At step S112, the first motion trajectory may be determined based on the offset.

Optionally, the motion trajectory of the sharp frames (e.g., the first images) with sharp textures may be modeled at a pixel level.

In practical applications, there are many curves that may be used to fit the motion trajectory, such as a Bessel function, a B-spline curve, and so on.

Optionally, the B-spline curve may be used to model the first motion trajectory in consideration of inserting trajectory points in the first motion trajectory for facilitating subsequent processing.

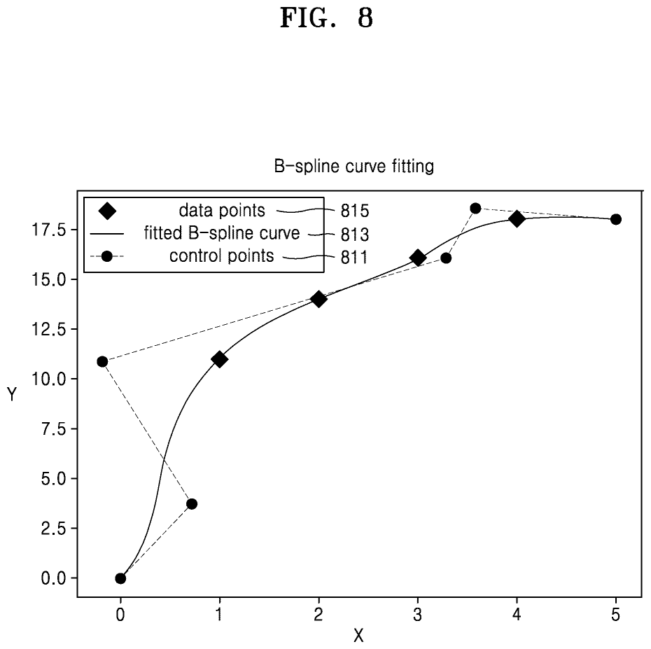

In an example, the B-spline curve may be used to model the offsets of pixels to obtain a trajectory of each pixel in the sharp frames, and thus h*w first motion trajectories (h is a height of video frame, w is a width of video frame) may be obtained. An example of fitting one motion trajectory by the B-spline is shown in FIG. 8. FIG. 8 is a schematic diagram of a fitted motion trajectory according to an embodiment of the present disclosure.

Specifically, when fitting, control points 811 of the B-spline may be computed based on an input offset of offset point, and then the motion trajectories may be fitted 813 using a least squares method, as shown in the following equations:

$$P ( t ) = {\sum }_{i = 0}^{n} {C}_{i} {B}_{i , k} ( t ) , n \geq k - 1 , t ∈ [ {t}_{k - 1} , {t}_{n + 1} ] \qquad Equation 2$$

where Cᵢ denotes the control points, B_{i,k}(t) denotes a B-spline basis function, n+1 denotes the number of control points, and k denotes the order of the B-spline curve.

$${B}_{i , 0} ( u ) = \{ \begin{matrix}1 , & if {u}_{i} \leq u < {u}_{i + 1} \\ 0 , & otherwise\end{matrix} \qquad Equation 3$$

$${B}_{i , p} ( u ) = \frac{u - {u}_{i}}{{u}_{i + p} - {u}_{i}} {B}_{i , p - 1} ( u ) + \frac{{u}_{i + p + 1} - u}{{u}_{i + p + 1} - {u}_{i + 1}} {B}_{i + 1 , p - 1} ( u ) \qquad Equation 4$$

where u denotes nodes, the nodes may be taken as separation points, or may simply be understood as points on the X-axis corresponding to the control points, e.g., X-axis values corresponding to points on the dashed line, as shown in FIG. 8, and an entire range [0-5] may be divided into different nodal intervals.

In this way, the first motion trajectory of the sharp frames may be obtained, as shown by the solid curve 813 in FIG. 8. Since the sharp frames have sharp textures, motion trajectories estimated between the sharp frames may be accurate.

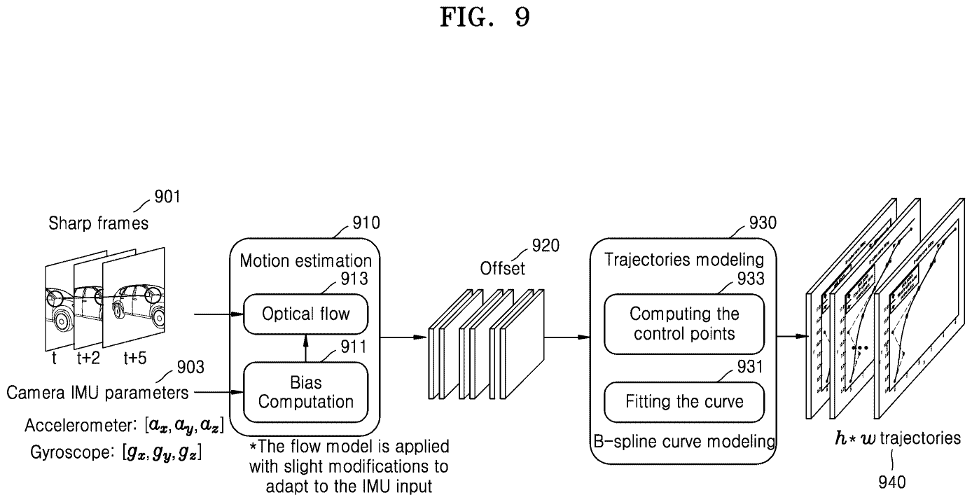

Based on at least one of the above embodiments, FIG. 9 illustrates a schematic diagram of a sharp frame trajectory modeling method according to an embodiment of the present disclosure. As shown in FIG. 9, the method may include the followings.

Based on the IMU parameters 903 of the acquisition device, a bias may be coarsely computed 911 as the prior information and input into an optical flow network 913 for motion estimation 910 together with the sharp frames 901 (e.g., assuming the sharp frames to be t-th frame, (t+2)-th frame, (t+5)-th frame, etc.), and the optical flow model may be applied with slight modifications to adapt to the inputs of the IMU parameters 903 after slight modification. The optical flow network may output the offsets 920 of all sharp frames compared to a predetermined sharp frame (e.g., the first frame).

The offsets 920 may then be modeled using the B-spline curve, and when fitting 931, the control points of the B-spline may be computed 933 based on the input offsets 920, and then the motion trajectories 930 may be fitted using the above equations 2-4 and h*w trajectories 940 (e.g., the first motion trajectory) may be obtained.

In the embodiment of the present disclosure, an optional implementation may be provided for the step S120, and may include the followings.

At step S121, motion trajectory points corresponding to the at least one second image may be inserted into the first motion trajectory.

Optionally, based on the at least one established first motion trajectory, the motion trajectory points corresponding to the second image may be uniformly inserted into the first motion trajectory.

At step S122, based on the blurriness and blur direction of the at least one second image, positions of the inserted motion trajectory points may be adjusted in the first motion trajectory, and the second motion trajectory may be obtained based on motion trajectory points having the adjusted positions.

This step may be understood as finely adjusting the trajectories of the blur frames, and adjusting the positions of the uniformly inserted blur points based on motion direction and speed.

Optionally, an adjustment direction of the motion trajectory points may correspond to the blur direction.

Optionally, an adjustment distance of the motion trajectory points may be proportional to the blurriness. Optionally, the MLP may be used to perform feature extraction on trajectory points of the sharp frames and trajectory points of the blur frames, respectively, while the blur map computed from the blur frames using the convolution may be used to characterize the speed of movement of the map in the X-axis and Y-axis directions, and to obtain an adjustment distance of the motion trajectory points of the blur frames.

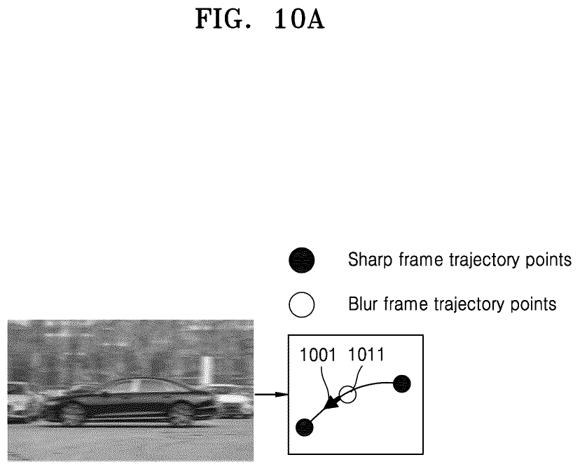

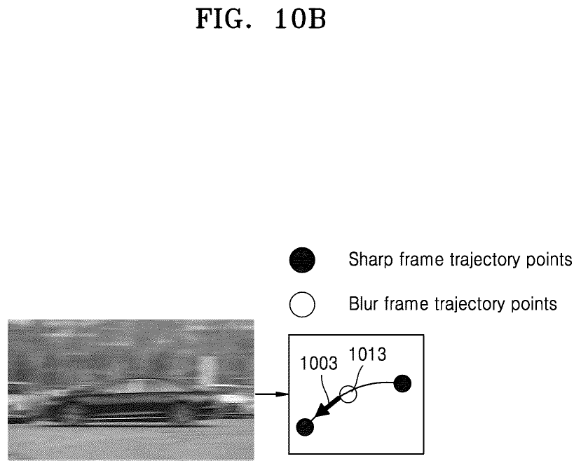

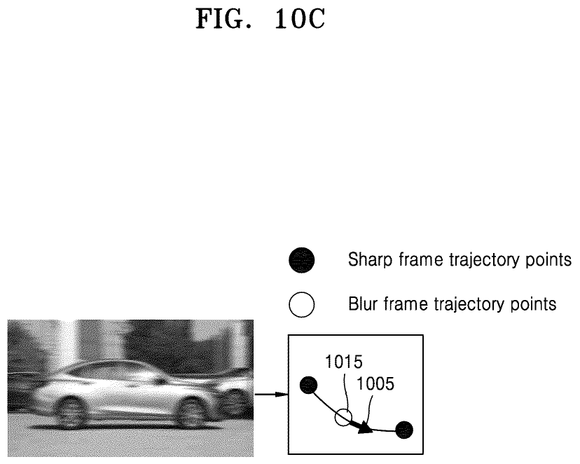

FIG. 10a is a schematic diagram of a motion trajectory point adjustment according to an embodiment of the present disclosure, FIG. 10b is a schematic diagram of a motion trajectory point adjustment according to an embodiment of the present disclosure, and FIG. 10c is a schematic diagram of a motion trajectory point adjustment according to an embodiment of the present disclosure. As shown in FIGS. 10a-10c, the X-axis is taken as an example to demonstrate the adjustment strategy.

In FIG. 10a, the blur direction 1001 is left and the blur degree is medium, then the motion trajectory points 1011 of the blur frames are moderately offset to the left.

In FIG. 10b, the blur direction 1003 is left and the blur degree is heavy, then the motion trajectory points 1013 of the blur frames are adjusted to the left by a greater offset.

In FIG. 10c, the blur direction 1005 is right and the blur degree is slight, then the motion trajectory points 1015 of the blur frames are slightly offset to the right.

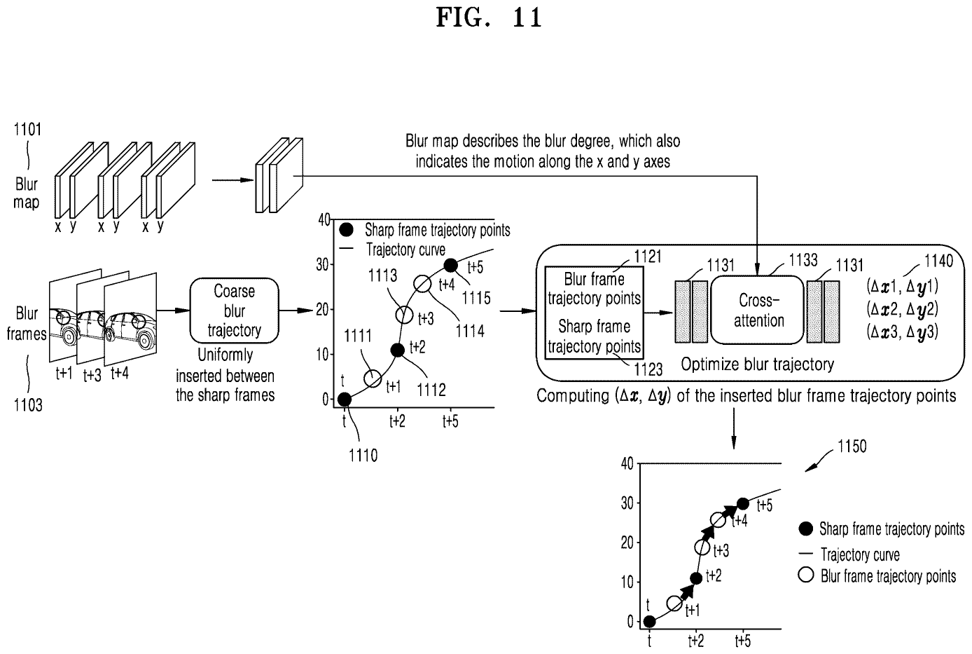

Based on at least one of the above embodiments, FIG. 11 illustrates a schematic diagram of a blur frame motion trajectory point localization method according to an embodiment of the present disclosure. As shown in FIG. 11, the method may include the followings.

Motion trajectory points of the blur frames 1103 (e.g., the second image) may be uniformly inserted in the established h*w trajectories (e.g., the first motion trajectory) of the sharp frames (e.g., the first images), e.g., gray motion trajectory points corresponding to the number of the blur frames may be uniformly inserted in two black points. For example, in FIG. 11, assuming that the sharp frames are t-th frame 1110, (t+2)-th frame 1112, (t+5)-th frame 1115, etc., (t+1)-th blur frame 1111 may be inserted between two sharp frames including the t-th frame 1110 and the (t+2)-th 1112 frame, and two blur frames including (t+3)-th frame 1113 and (t+4)-th frame 1114 may be inserted between two sharp frames including the (t+2)-th frame 1112 and the (t+5)-th frame 1115, to obtain a coarse blur frame trajectory.

Then, the blur frame trajectory may be finely adjusted, and the MLP 1131 and a cross-attention network 1133 may be used to extract features from the motion trajectory points of the sharp frames 1123, the motion trajectory points of the blur frames 1121, as well as from the blur map 1101 computed from the blur frames. In addition to describing the blur degree (e.g., the speed of motion), the blur map 1101 may indicate the direction of blurring (e.g., the direction of motion) along the X-axis and the Y-axis, and thus an offset 1140 (Δx, Δy) of the inserted blur frame trajectory point may be computed, and the uniformly inserted blur frame trajectory points may be adjusted in turn according to the direction and speed of motion, and finally h*w accurate video trajectories 1150 may be obtained.

In the embodiment of the present disclosure, an optional implementation may be provided for the step S130, and may include the followings.

At step S131, offset information and scale change information between images of the video may be determined based on the second motion trajectory.

At step S132, the deblurring processing may be performed on the at least one second image based on the offset information and the scale change information.

In the embodiment of the present disclosure, in order to enable subsequent deblurring model(s) to effectively utilize the determined motion trajectories, a specific inter-frame motion relation (also referred to as inter-frame trajectory relation or motion descriptor) including the offset information (also referred to as offset descriptor) and the scale change information (also referred to as scale descriptor) may be extracted from an abstract trajectory function as guidance information for the deblurring model(s).

Optionally, the offset information and the scale change information may be with respect to the predetermined first image, which has been described above and will not be repeated herein. Alternatively, the offset information and the scale change information may be between adjacent image frames.

In the embodiment of the present disclosure, the offset descriptor may be obtained by an offset relation of pixel points. Taking a video containing T frames and h*w extracted trajectories as an example, (T−1)*h*w*2 pixel offset information in the X-axis and the Y-axis with respect to the predetermined first image may be obtained, or (T−1)*h*w*2 pixel offset information in the X-axis and the Y-axis between adjacent image frames may be obtained.

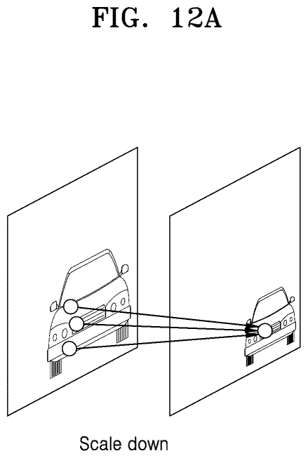

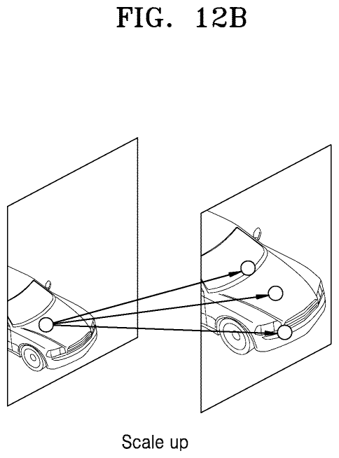

The scale descriptor may be determined by the convergence or divergence of trajectories. FIG. 12a is a schematic diagram of a scale-down situation according to an embodiment of the present disclosure, and FIG. 12b is a schematic diagram of a scale-up situation according to an embodiment of the present disclosure. For example, as shown in FIG. 12a, a car is gradually driving off into the distance, and the trajectories of pixel points on the car are converging, which case corresponds to scale down. Another example is shown in FIG. 12b, the car is coming from a distance and the trajectories are diverging, which case corresponds to scale up. Taking a video containing T frames and h*w extracted trajectories as an example, (T−1)*h*w*1 scale change information with respect to the predetermined first image may be obtained, or (T−1)*h*w*1 scale change information between adjacent image frames may be obtained.

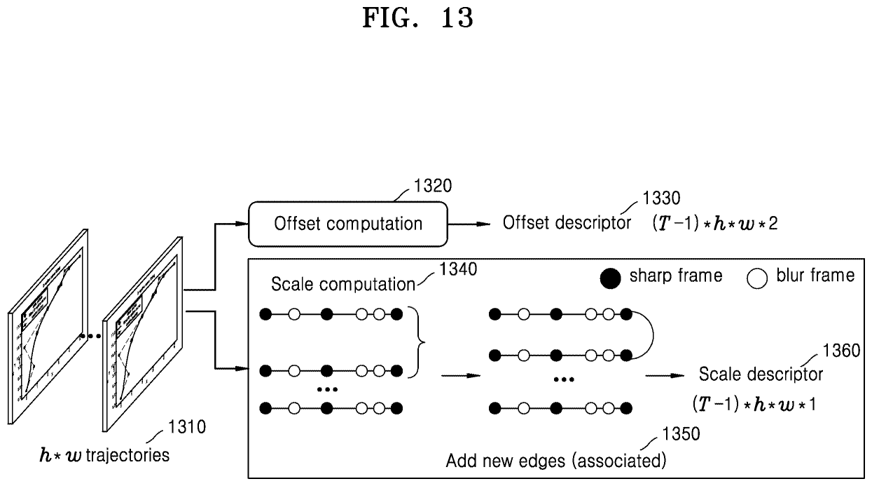

Based on at least one of the above embodiments, FIG. 13 illustrates a schematic diagram of a method for extracting an inter-frame relation according to an embodiment of the present disclosure. As shown in FIG. 13, the method may include the followings.

The extracted h*w trajectories 1310 may be computed by an offset relation of pixel points to obtain the (T−1)*h*w*2 offset descriptors 1330, nodes and edges may be built for the h*w trajectories, and new edges 1350 may be added to related pixels at the same position for determining the convergence or divergence of trajectories to obtain the (T−1)*h*w*1 scale descriptors 1360.

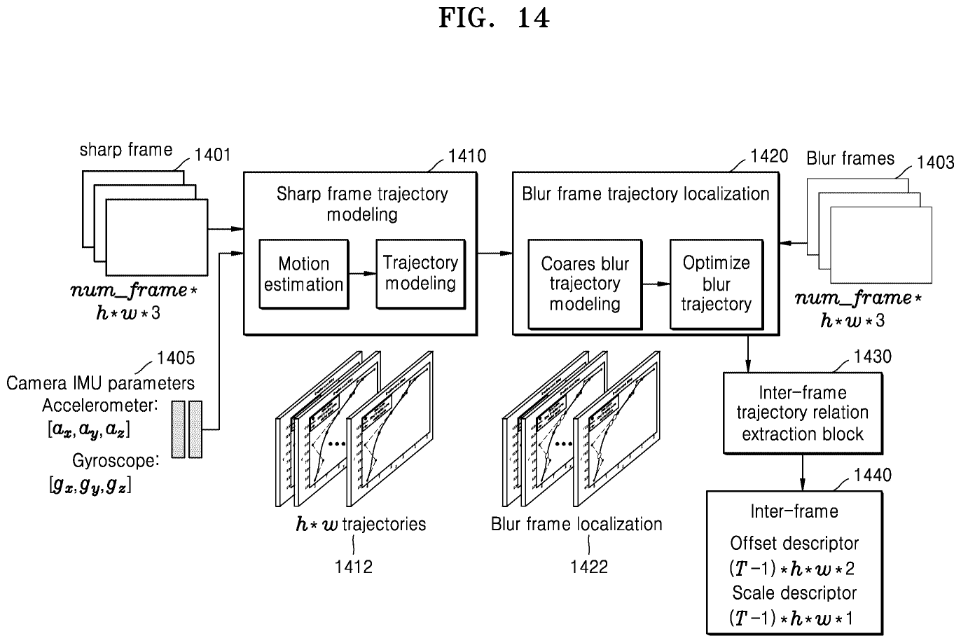

Based on at least one of the above embodiments, FIG. 14 illustrates a schematic diagram of a blur frame trajectory localization method according to an embodiment of the present disclosure. As shown in FIG. 14, the inputs may be sharp frames 1401, blur frames 1403 and camera IMU parameters 1405, and the outputs may be inter-frame trajectory relations or motion descriptors 1440, including the offset descriptor and the scale descriptor. The method may include the followings.

Sharp Frame Trajectory Modeling 1410: num_frame*h*w*3 (where num_frame denotes the number of frames, h denotes the height of frame, w denotes the width of frame, 3 denotes the number of channels of the frame, e.g., RGB three-channels) motion trajectories of the sharp frames may be modeled at a pixel level. Firstly, motion estimation may be performed using an optical flow model with the camera IMU parameters 1405 to predict offsets of other sharp frames compared to the first sharp frame. Then, the trajectory of each pixel in the sharp frames may be modeled using a B-spline curve to obtain h*w trajectories 1412. The sharp frames have clear textures, so the motion estimation between the sharp frames may generate an accurate motion trajectory.

Blur Frame Trajectory Localization 1420: precise trajectory positions of the blur frames may be localized in a coarse-to-fine manner based on the established h*w trajectories 1412 of the sharp frames. Firstly, the blur frames 1403 may be uniformly inserted into the modeled trajectories and coarse blur trajectories may be obtained. However, considering that motion is not uniform, the blur map of the blur frames may be used to adjust the positions of motion trajectory points of the blur frames, and final precise trajectories may be obtained.

Inter-frame Trajectory Relation Extraction 1430: based on the precise trajectories, an inter-frame trajectory relation may be extracted, including the offset descriptor and the scale descriptor, which are the guidance information for the deblurring model. Optionally, the offset descriptor represents one describing the offset in the horizontal and vertical directions based on the first frame. The scale descriptor represents a pixel-level scale transformation based on the first frame.

The blur frame trajectory localization method provided in the embodiment of the present disclosure may accurately localize motion states of the blur frames under the guidance of the sharp frames, which is capable of overcoming the problem that videos with large motion blur are unable to predict accurate motion trajectories based on the blur frames themselves.

In the embodiment of the present disclosure, an optional implementation may be provided for the step S132, and may include the followings.

At step S1321, noise addition may be performed on the at least one second image to obtain at least one fourth image.

Optionally, the at least one second image may be encoded as a latent space feature, and forward diffusion and reverse denoising processes may be performed in the latent space.

At step S1322, first denoising processing may be performed at least once on the at least one fourth image based on the at least two first images, the offset information and the scale change information, to obtain a result of the deblurring processing of the at least one second image.

In the embodiment of the present disclosure, the offset information and the scale change information may be input into the diffusion model for deblurring processing, and the deblurring processing may make reference to texture information from the at least two first images, and thus a video with clear textures may be obtained.

In the embodiment of the present disclosure, an optional implementation may be provided for the step S1322. Specifically, the performing first denoising processing on the at least one fourth image based on the at least two first images, the offset information and the scale change information, may include the followings.

At step S310, phase features of the at least one fourth image may be adjusted based on phase features of the at least two first images to obtain updated phase features.

In order to ensure consistency of textures of the blur frames (e.g., the at least one second image) and the sharp frames (e.g., the at least two first images), the sharp frames may be utilized for deblurring processing. Because most luminance information concentrates on amplitudes, while structural information is closely related to phases, an embodiment of the present disclosure may use a Fourier-Guided Interaction, in which the deblurring processing mainly involves texture feature (e.g., phase) interaction.

Specifically, a Fourier transform may be first performed to adjust phase features of the at least one fourth image based on phase features of the at least two first images. Optionally, the updated phase features may be obtained after directly multiplying the phase features of the at least two first images and the phase features of the at least one fourth image by softmax, for replacing original phase features of the at least one fourth image. The multiplication operation of the two phase features may be understood as obtaining a similarity matrix by an attention computation, for determining a probability that each pixel obtains information from the two phase features.

At step S320, first guidance information may be obtained based on the updated phase features and amplitude features of the at least one fourth image.

In the embodiment of the present disclosure, original amplitude features of the at least one fourth image may be kept unchanged, and the first guidance information may be obtained by an inverse Fourier transform in conjunction with the updated phase features.

In the embodiment of the present disclosure, only the texture feature (e.g., phase) interaction may be performed, thereby avoiding interference caused by inconsistency in luminance between the sharp frames and the blur frames.

At step S330, the first denoising processing may be performed on the at least one fourth image based on the first guidance information, the offset information and the scale change information.

In the embodiment of the present disclosure, the offset information and the scale change information may be input into the diffusion model for deblurring processing, and the deblurring processing may make reference to texture information from the first guidance information, thereby obtaining a video with clear textures.

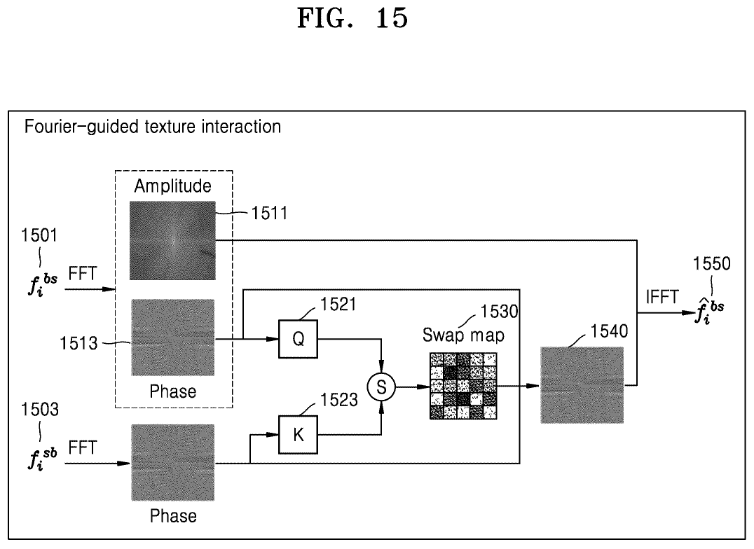

Based on at least one of the above embodiments, FIG. 15 illustrates a schematic diagram of a Fourier-Guided Texture Interaction (FGTI) according to an embodiment of the present disclosure. As shown in FIG. 15, a process may include the followings.

Assuming that

$${f}_{i}^{b s}$$

1501 are intermediate features of the blur frames (e.g., the fourth image) and

$${f}_{i}^{s b}$$

1503 are intermediate features of the sharp frames (e.g., the first images), firstly a fast Fourier transform (FFT) may be performed on

$${f}_{i}^{b s}$$

1501 and

$${f}_{i}^{sb}$$

1503 to obtain the corresponding phase 1513, 1515 and amplitude 1511 features, respectively. Query (Q) 1521 features may be extracted from the phase 1513 features corresponding to the blur frames, Key (K) 1523 features may be extracted from the phase 1515 features corresponding to the sharp frames, and after multiplying the Q 1521 features and the K 1523 features, a swap map 1530 may be obtained by softmax. Based on the swap map 1530, the phase 1513 features corresponding to the blur frames and the phase 1515 features corresponding to the sharp frames, the updated phase 1540 features may be obtained. The updated phase 1540 features and the amplitude 1511 features corresponding to the blur frames may be processed by an Inverse Fast Fourier Transform (IFFT) to obtain

$${\hat{f}}_{i}^{bs}$$

1550 (e.g., the first guidance information).

In the embodiment of the present disclosure, an optional implementation may be provided for the step S1322. Specifically, the performing first denoising processing on the at least one fourth image based on the at least two first images the offset information and the scale change information, may include the followings.

At step S410, pixels in the at least one fourth image may be clustered based on the offset information and the scale change information, to obtain a cluster result 1630.

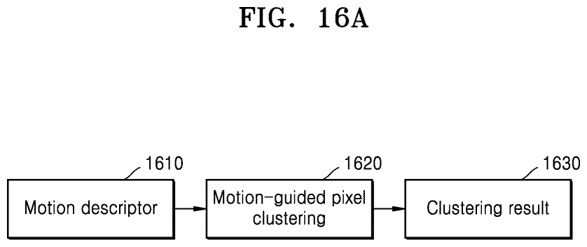

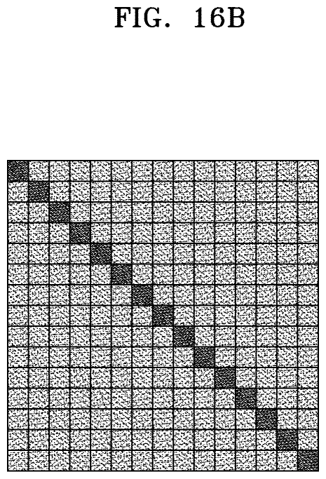

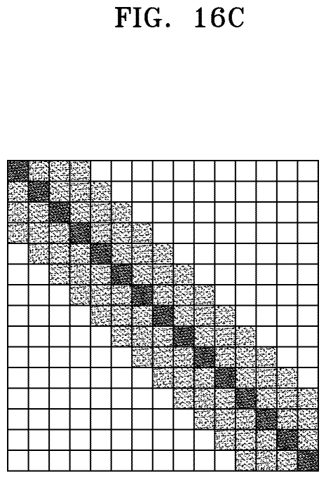

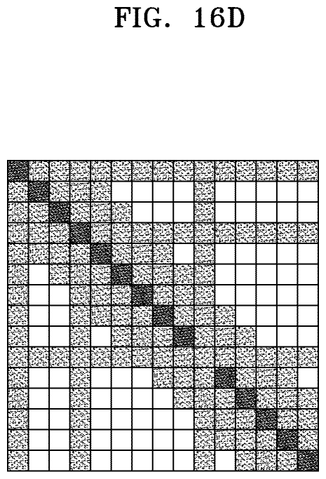

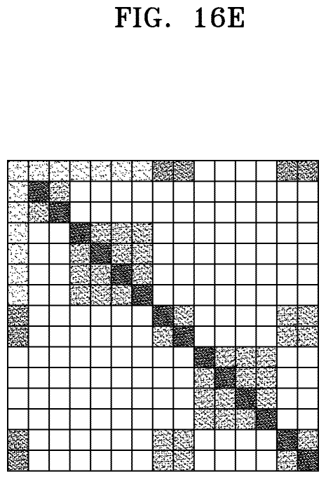

FIG. 16a is a schematic diagram of a pixel clustering method according to an embodiment of the present disclosure, FIGS. 16b-16d are schematic diagrams of examples of a self-attention window according to embodiments of the present disclosure, and FIG. 16e is a schematic diagram of a motion information based self-attention window according to an embodiment of the present disclosure. Step S410 may also be understood as a motion clustering, where all pixels in a motion video are clustered by means of pixel-level motion descriptors 1610 (e.g., the offset information and the scale change information), as shown in FIG. 16a, to obtain pixel points having the same motion, e.g., objects having the same motion are grouped together. For example, if a truck is moving in a video sequence, pixels related to the truck in the video sequence may be clustered together as a class.

At step S420, the at least one fourth image is processed using at least one concatenated attention network, based on the at least two first images and the cluster result 1630.

The deblurring processing may be configured to remove motion blur in the video, and the use of the at least one attention network may ensure the coherence and consistency of video frames.

In an optional implementation, the at least one concatenated attention network may include at least one self-attention network, and the step S420 may include the followings.

At step S510, based on the clustering result 1630, a first attention computation may be performed on pixels of a same type in at least one fifth image using the self-attention network to obtain a first attention result, wherein the at least one fifth image is obtained based on the at least one fourth image, or the at least one fifth image is obtained based on the at least one fourth image and the at least two first images.

In the embodiment of the present disclosure, a self-attention (e.g., first attention) operation may be performed based on the clustering result to obtain a first attention result.

The at least one fourth image may be used as at least one fifth image; or, the at least one fifth image may be obtained by arranging the at least one fourth image and the at least two first images; or, the at least one fifth image may be an output of a previous at least one first denoising processing, e.g., the at least one fifth image may be obtained by performing the first denoising processing one or more times on the at least one fourth image; or, the at least one fifth image may be obtained by arranging the output of the previous first denoising processing and the at least two first images (and/or the results of one or more luminance adjustment processing thereof, e.g., the at least two first images and the results of one or more times of luminance adjustment processing thereof are first fused, wherein the luminance adjustment processing will be described below). That is, the at least one fifth image may be obtained by arranging with the at least two first images (and/or the results of one or more times of luminance enhancement processing thereof) after performing the first denoising processing one or more times on the at least one fourth image.

Alternatively, based on similar principles, at least one eighth image may be obtained based on the at least one fourth image, at least two ninth images may be obtained based on the at least two first images, and the at least one eighth image or the at least two ninth images may be input into an attention network for processing.

Briefly, the inputs to the at least one concatenated attention network may include sharp frames and blur frames, wherein the sharp frames used here may be original sharp frames or sharp frames from any stage of a prefatory processing. Similarly, the blur frames used here may be original blur frames or blur frames from any stage of the prefatory processing (the attention network may be similar hereinafter, and will not be repeated herein), which may be realized by designing a structure or connection method of the network, etc., and may be designed by those skilled in the art according to an actual implementation, and the embodiment of the present disclosure is not limited herein.

Optionally, the self-attention network may employ a global window as shown in FIG. 16b (where attention computation is performed between all pixels), or may employ an adjacent window as shown in FIG. 16c (where attention computation is performed between adjacent pixels), or may employ a combination of a sparse global window and an adjacent window as shown in FIG. 16d (where attention computation is performed between partially adjacent pixels).

Or optionally, an embodiment of the present disclosure may use a self-attention window based on motion information, as shown in FIG. 16e, where when performing the self-attention computation, tokens with a same type of motion are interacted in the image itself according to the results of motion clustering, so as to make the model more focused and reduce redundant information.

At Step S520, the at least one fourth image may be processed based on the first attention result.

In the embodiment of the present disclosure, the first attention result output from the self-attention network may ensure the coherence of image motion.

In an optional implementation, the at least one concatenated attention network may include at least one Inter-Frame Attention (IFA) network, and the step S420 may include the followings.

At step S610, the at least two first images may be scaled based on the scale change information and the clustering result, and the at least two scaled first images may be fused to obtain a sixth image.

In the embodiment of the present disclosure, a sharp frame (e.g., first image) token with the same motion as the current blur frame (e.g., the fourth image) token may be obtained according to the clustering result, and scale deformation may be performed on the sharp frames in conjunction with the scale change information (e.g., scale descriptor) in the motion descriptor.

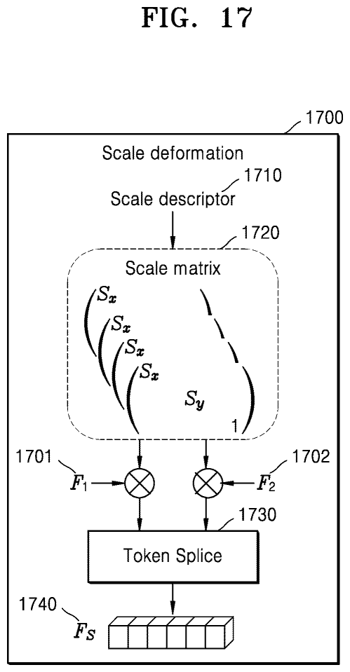

FIG. 17 is a schematic diagram of a scale deformation method according to an embodiment of the present disclosure. As shown in FIG. 17, according to a scale matrix 1720 provided by the scale descriptor 1710, the sharp frame tokens (F₁ 1701 and F₂ 1702) may be converted to tokens of the same size as the current blur frame token, and then the tokens of different sharp frames may be spliced together, to obtain Fₛ 1740 (e.g., the sixth image).

At step S620, a second attention computation may be performed on the sixth image and the at least one fourth image using the inter-frame attention network to obtain a second attention result.

In the embodiment of the present disclosure, the sixth image may be subjected to a cross-attention (e.g., second attention) computation with the current blur frame token to generate sharp local textures to obtain the second attention result.

At step S630, the at least one fourth image may be processed based on the second attention result.

In the embodiment of the present disclosure, the local textures may be generated based on the sharp frames, and then global structural timing consistency may be ensured according to the motion information, such that the second attention result outputted by the inter-frame attention network may ensure the consistency between frames.

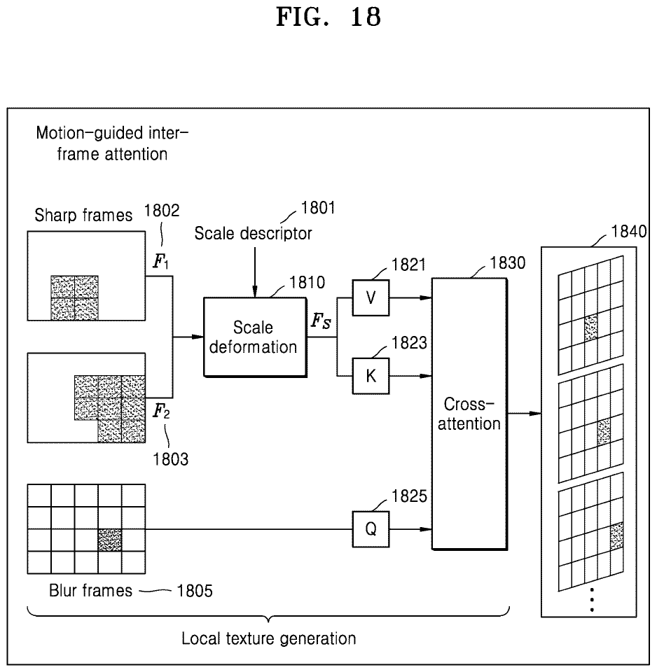

Based on at least one of the above embodiments, FIG. 18 illustrates a schematic diagram of a motion-guided inter-frame attention according to an embodiment of the present disclosure. As shown in FIG. 18, a process may include the followings.

According to the scale descriptor 1801, the sharp frame tokens (F₁ 1802 and F₂ 1803) may be subjected to the scale deformation 1810 to be converted to tokens of the same size as the current blur frame token, then the tokens of different sharp frames may be spliced together, to obtain Fₛ (e.g., the sixth image). The extracted V 1821 (value) features and K 1823 (key) features of Fₛ may be subjected to a cross-attention 1830 computation with the Q 1825 (query) features extracted from the blur frames 1805, to generate the local textures (e.g., the second attentional result) for processing the blur frames to obtain a video sequence with clear textures.

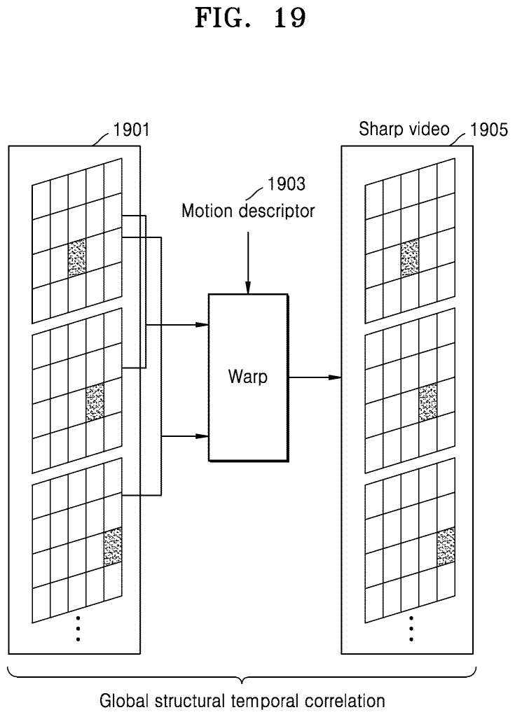

FIG. 19 is a schematic diagram of a video deformation according to an embodiment of the present disclosure. In the embodiment of the present disclosure, in order to ensure the smoothness of video and the consistency of object's motion, as shown in FIG. 19, the currently generated video frames 1901 may be warped according to the motion trajectory information (e.g., motion descriptor 1903) to ensure a global structural temporal correlation according to the motion information, e.g., to ensure that each point in the video sequence strictly conforms to an optimal motion trajectory, so as to finally obtain a clear video sequence 1905.

In the embodiment of the present disclosure, as shown in FIG. 7, a video may include at least one clip, each clip may include at least two first images and at least one second image, and at least one concatenated attention network may include at least one inter-clip attention network, and the step S420 may include the followings.

At step S710, a third attention computation may be performed on the at least one first clip subjected to the deblurring processing and a second clip to be subjected to the deblurring processing using the inter-clip attention network, to obtain a third attention result.

The number of the first clip may be set by those skilled in the art according to an actual implementation. For example, the first clip may be a previous video clip, etc., and the embodiment of the present disclosure is not limited herein.

Optionally, the information of the first clip that has been subjected to the deblurring processing may be cached so as to be read for use in this step.

In the embodiment of the present disclosure, the cached information and current clip features may be subjected to the cross-attention (e.g., third attention) computation to obtain a third attention result.

At step S720, the at least one fourth image corresponding to the second clip may be processed based on the third attention result.

In the embodiment of the present disclosure, the third attention result outputted by the inter-clip attention network may ensure the consistency between different video clips.

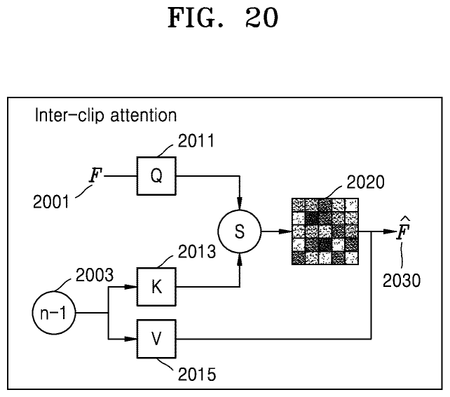

Based on at least one of the above embodiments, FIG. 20 illustrates a schematic diagram of an inter-clip attention according to an embodiment of the present disclosure. As shown in FIG. 20, a process may include the followings.

Feature K 2013 and feature V 2015 may be extracted from the cached information (n−1) 2003 of the previous video clip output, feature Q 2011 may be extracted from current clip features (F 2001), a cross-attention computation may be performed on these features to fuse them with the feature V 2015 of the cached information, so as to obtain a processing result (\hat{F}) 2030 of the current clip features. Optionally, the cached information may be attention network's output features of the last step of the diffusion model.

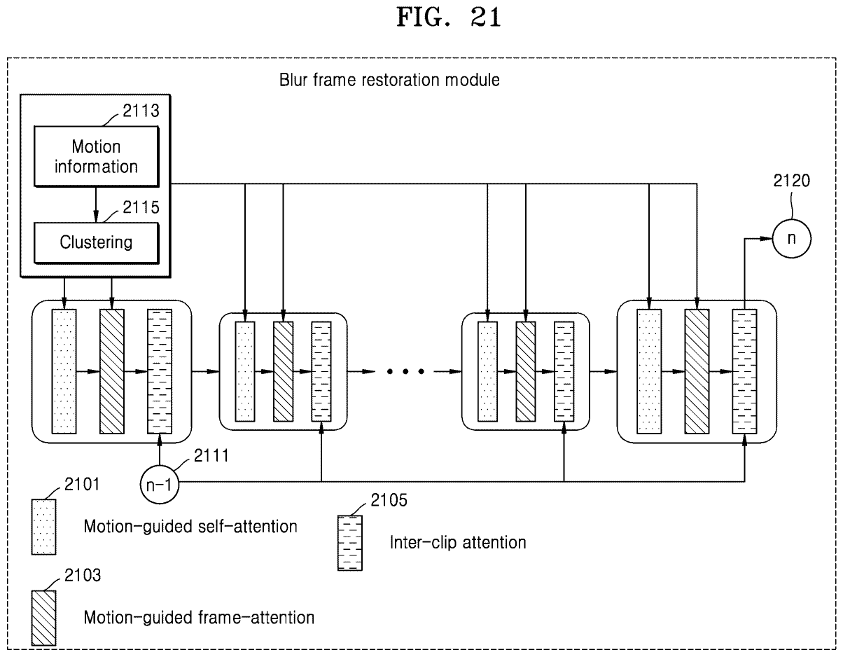

Based on at least one of the above embodiments, FIG. 21 illustrates a schematic diagram of a deblurring processing method according to an embodiment of the present disclosure. As shown in FIG. 21, the method may be performed by a Blur Frame restoration (BFR) module to remove motion blur from a video, and the module may include concatenated sub-attention modules, each of which includes a motion information-guided self-attention network 2101, a motion information-guided inter-frame attention network 2103, and an inter-clip attention network 2105, and the method may include:

All pixels in a motion video clip may be clustered by a pixel-level motion descriptor to obtain pixel points with the same motion.

In conjunction with the clustering result 2115, the blur video features 2113 may pass through each sub-attention module in turn, wherein the self-attention network and the inter-frame attention network in each sub-attention module perform the processing based on the clustering result, and the inter-segment attention network in each sub-attention module performs the processing based on the cached information (n−1) 2111 of the previous video segment output, and finally output sharp video features (n) 2120.

Optionally, the output sharp video features (n) 2120 may be cached for the processing of the next video clip (n+1).

It should be noted that the above model structures are only schematic descriptions and do not constitute a limitation on the embodiments of the present disclosure, and appropriate changes based on these instances may also be applicable to the present disclosure. For example, the adjustment of positions of the three attentional networks, or the adjustment of the number of attentional networks, and so on shall be included in the scope of protection of the present disclosure.

In the embodiments of the present disclosure, considering that the actively captured short exposure frames (e.g., sharp frames) have rich texture but low luminance, while the blur frames have motion blur but have normal luminance, luminance adjustment processing may be performed on the at least two first images based on the at least one second image.

Specifically, the luminance adjustment processing of the at least two first images based on the at least one second image may include the followings.

At step S810, noise addition may be performed on the at least two first images to obtain at least two seventh images.

Optionally, both the at least two first images and the at least one second image may be encoded as a latent space feature, and forward diffusion and reverse denoising processes may be performed in the latent space.

At step S820, second denoising processing may be performed at least once on the at least two seventh images based on the at least one second image to obtain a result of the luminance adjustment processing of the at least two first images.

In the embodiment of the present disclosure, the luminance adjustment processing may also be performed by a diffusion model, and the luminance adjustment processing makes reference to luminance information from the at least one second image, so as to obtain a video with consistent luminance and to ensure the smoothness of the video.

In the embodiment of the present disclosure, an optional implementation may be provided for the step of “performing luminance adjustment processing on the at least two first images based on the at least one second image” or the step S820. Specifically, the performing the first denoising processing on the at least one fourth image based on the at least two first images, the offset information and the scale change information may include the followings.

At step S910, amplitude features of at least two seventh images may be adjusted based on amplitude features of the at least one second image to obtain the updated amplitude features.

In order to ensure the consistency between luminance of the sharp frames (e.g., the at least two seventh images) and luminance of the blur frames (e.g., the at least one second image), the luminance of the sharp frames may be adjusted according to the luminance of the blurred frames. Because most luminance information concentrates on the amplitudes, while structural information is closely related to the phases, an embodiment of the present disclosure may use a Fourier-Guided Interaction, in which the luminance adjustment processing mainly involves a luminance information (e.g., amplitude) interaction.

Specifically, a Fourier transform may be first performed to adjust amplitude features of the at least two seventh images based on amplitude features of the at least one second image. Optionally, the updated amplitude features may be obtained after directly multiplying the amplitude features of the at least one second image and the amplitude features of the at least two seventh images by softmax, for replacing original amplitude features of the at least two seventh images. The multiplication operation of the two amplitude features may be understood as obtaining a similarity matrix by an attention computation, for determining a probability that each pixel obtains information from the two amplitude features.

At step S920, second guidance information may be obtained based on the updated amplitude features and phase features of the at least two seventh images.

In the embodiment of the present disclosure, original phase features of the at least two seventh image may be kept unchanged, and the second guidance information may be obtained by an inverse Fourier transform in conjunction with the updated amplitude features.

In the embodiment of the present disclosure, only the luminance feature (amplitude) interaction may be performed to avoid interference with the clear textures of the sharp frames.

At step S930, the luminance adjustment processing may be performed on the at least two first images based on the second guidance information.

Specifically, a second denoising processing may be performed on the at least two seventh images once based on the second guidance information. That is, the luminance adjustment processing of the diffusion model may make reference to luminance information from the second guidance information, thereby obtaining a video with consistent luminance.

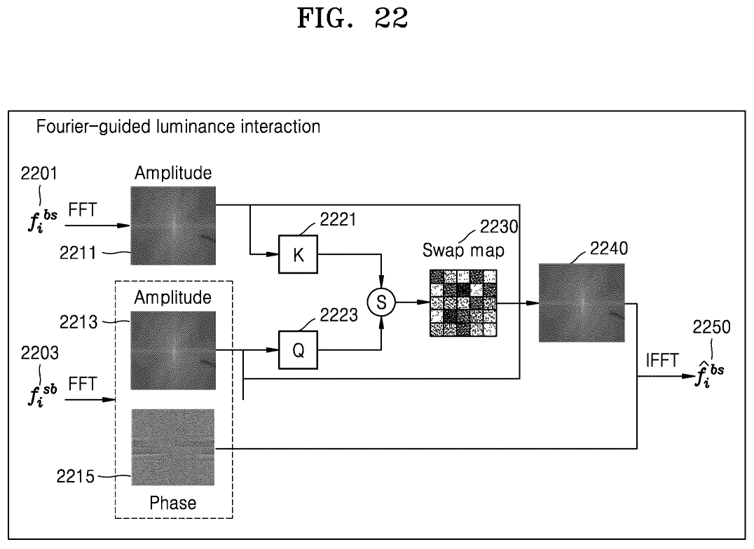

Based on at least one of the above embodiments, FIG. 22 illustrates a schematic diagram of a Fourier-Guided Luminance Interaction (FGLI) according to an embodiment of the present disclosure. As shown in FIG. 22, a process may include the followings.

Assuming that

$${f}_{i}^{bs}$$

2201 are intermediate features of the blur frames (e.g., the second images) and

$${f}_{i}^{sb}$$

2203 are intermediate features of the sharp frames (e.g., the seventh images), firstly the FFT may be performed on

$${f}_{i}^{bs}$$

2201 and

$${f}_{i}^{sb}$$

2203 to obtain the corresponding phase 2215 and amplitude 2211, 2213 features, respectively. Q 2223 features may be extracted from the amplitude 2213 features corresponding to the sharp frames, K 2221 features may be extracted from the amplitude 2211 features corresponding to the blur frames, and after multiplying the Q 2223 features and the K 2221 features, a swap map 2230 may be obtained by softmax. Based on the swap map 2230, the amplitude 2211 features corresponding to the blur frames, the amplitude 2213 features corresponding to the sharp frames, and the updated amplitude 2240 features may be obtained. The updated amplitude 2240 features and the phase 2215 features corresponding to the sharp frames may be subjected to IFFT processing to obtain

$${\hat{f}}_{i}^{sb}$$

2250 (e.g., the second guidance information).

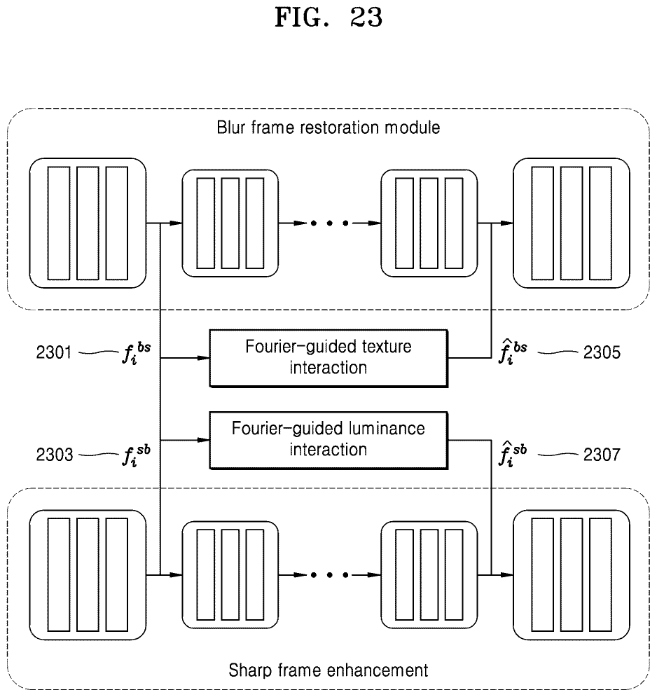

Based on at least one of the above embodiments, FIG. 23 illustrates a schematic diagram of a Fourier-guided interaction manner according to an embodiment of the present disclosure, where the deblurring processing and the luminance adjustment processing may be performed as a dual-branch interaction, while realizing the consistency of textures and luminance between the sharp frames and the blur frames, as shown in FIG. 23, including a Fourier-guided texture interaction and a Fourier-guided luminance interaction, and a process may include the followings.

The task of blur frame restoration branch is to utilize the sharp frames for deblurring processing. Thus, when intermediate features

$${f}_{i}^{bs}$$

2301 of the blur branch interact with features

$${f}_{i}^{sb}$$

2303 of the other branch, the Fourier-guided texture interaction may be performed, which can be seen, for example, in an execution process of FIG. 15, and will not be repeated herein.

The task of sharp frame enhancement branch is to adjust the luminance of the sharp frames according to the luminance of the blur frames. Thus, when intermediate features

$${f}_{i}^{sb}$$

2303 of the sharp frame branch interact with intermediate features

$${f}_{i}^{bs}$$

2301 of the other branch, the Fourier-guided luminance interaction may be performed, which can be seen, for example, in an execution process of FIG. 22, and will not be repeated herein.

Optionally, the blur frame restoration branch may adopt a model structure as shown in FIG. 21, but is not limited thereto. Optionally, the sharp frame enhancement branch may adopt a model structure as shown in FIG. 21, or may adopt any attention network structure, and the embodiment of the present disclosure is not limited herein.

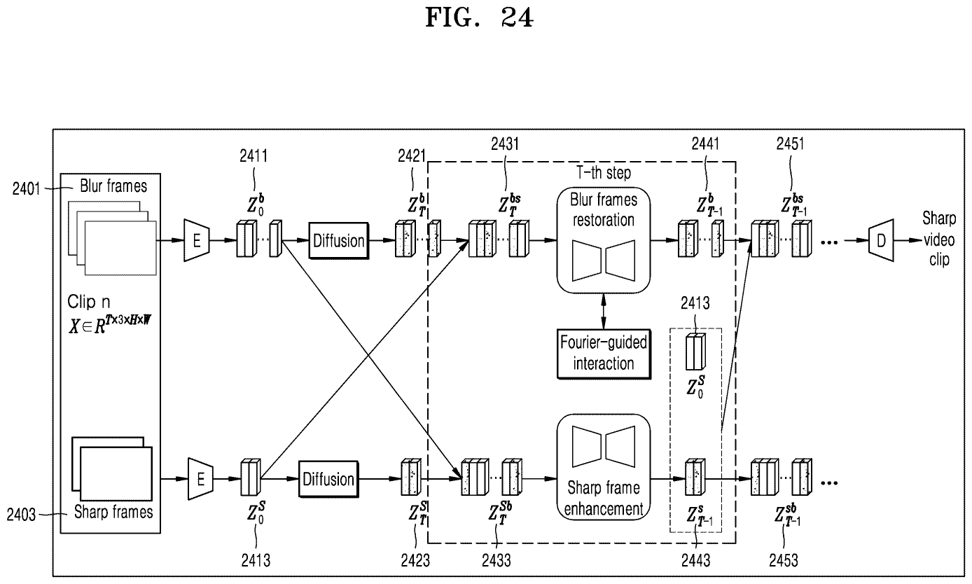

Based on at least one of the above embodiments, FIG. 24 illustrates a schematic diagram of a dual-branch interaction diffusion model according to an embodiment of the present disclosure. The model shown in FIG. 24 may be provided to perform deblurring processing on the blur frames and performing luminance enhancement on the sharp frames according to a motion descriptor, where the two branches (i.e., the blur frame restoration branch and the sharp frame enhancement branch) focus on different tasks, and the two branches may be used to deal with the blur frame restoration and the sharp frame luminance enhancement respectively, and where the branches interact with each other to ensure the consistency between the frames. Moreover, input conditions of the two branches may be different at each step, and the video quality may be improved. The interaction between the two branches ensures the independence of the two tasks while maintaining the consistency of the results. A process may include the followings.

Given a video (or video segment, or video clip, e.g. Clip n) X∈ [symbol] ^{T×3×H×W} (where T denotes the number of video frames, e.g., the number of a Clip, H denotes the height of video frames, W denotes the width of video frames, and 3 denotes the number of channels of the video frames, e.g., RGB three-channel), the video may be firstly encoded as a latent space feature Z=E(X), Z∈ [symbol] ^{T×c×h×w} (where the number of channels and the height and width of images may change after being encoded into the latent space). Here, Z^{b} denotes the latent space features of the blur frames and Z^{s} denotes the latent space features of the sharp frames. A forward diffusion (adding noise) and at least one reverse denoising process may be performed in this latent space.

In the inference phase, input conditions for different steps of the blur frame restoration branch may be different. For example, the input conditions for T-th step may be the original sharp frame features

$${Z}_{o}^{s}$$

2411 and the noise

$${Z}_{T}^{b}$$

2421, the input conditions for T−1-th step may be features after the fusion of the original sharp frame features

$${Z}_{o}^{s}$$

2413 with that sharp frame features

$${Z}_{T - 1}^{s}$$

2441 enhanced by the sharp frame enhancement module. Other inverse denoising processes may be similar to the above-described processes and will not be repeated.

Here, the blur frame restoration module, the sharp frame enhancement module, and the Fourier-guided interaction used in each step may adopt the scheme as shown in FIG. 23, and will not be repeated herein.

Optionally, the two branches may be unsynchronized, e.g., the blur frame restoration module processes multiple steps, while the sharp frame enhancement module processes one step. The information on to which step of the sharp frame enhancement branch each step of the blur frame restoration branch may make reference may be set by those skilled in the art according to an actual implementation, and vice versa, and the embodiment of the present disclosure is not limited herein.

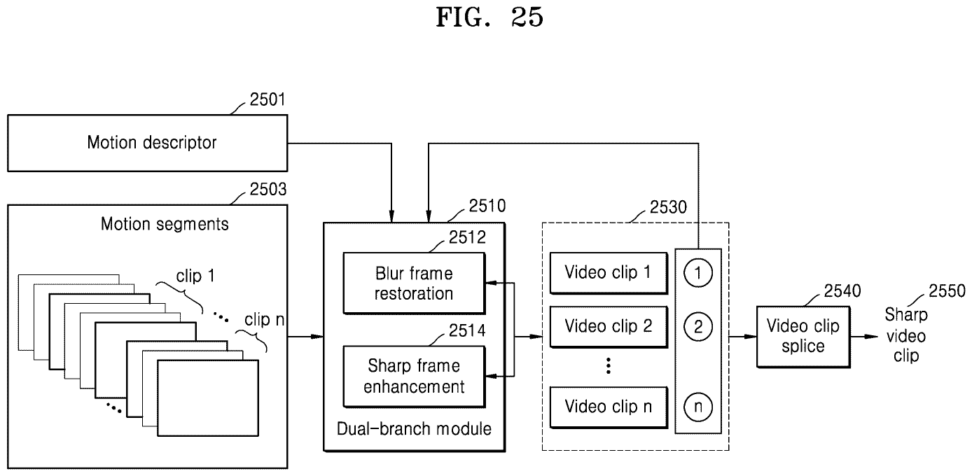

In the embodiment of the present disclosure, the processing of the dual-branch interaction diffusion model may be based on each motion segment in the video, the model inputs may be a motion descriptor and a motion segment in the video, the motion segment may include a plurality of clips, one clip may include two sharp frames and one or more blur frames in between, the sharp frames may have rich texture but low luminance, while the blur frames may have motion blur but normal luminance. The motion segment may be processed together, and the dual-branch interaction diffusion model (or a dual-branch module) may process one clip each time and then splice the clips to output a sharp motion segment video. FIG. 25 is a schematic diagram of processing a plurality of video clips according to an embodiment of the present disclosure. As shown in FIG. 25, a process may include the followings.

The blur frames in one clip, in conjunction with the motion descriptor 2501, may pass through the blur frame restoration branch 2512 in the dual-branch module 2510, to remove the motion blur. At the same time, the sharp frames in one clip may pass through the sharp frame enhancement branch 2514 for luminance adjustment to obtain images with the same luminance as the blur frames. The two branches (i.e., the blur frame restoration branch 2512 and the sharp frame enhancement branch 2514) may interact with each other in the process to ensure the consistency between frames. At the same time, the two branches may ensure the consistency between clips in conjunction with the cached information of the previous clip, thereby obtaining a clip with consistent luminance and clear texture. After all the clips are processed, the clips 2530 may be spliced 2540. A dual-branch structure may ensure the consistency within the clips 2530, the cached information may ensure the consistency between the clips 2530, and a sharp and coherent motion segment video may be obtained by directly splicing the clips.

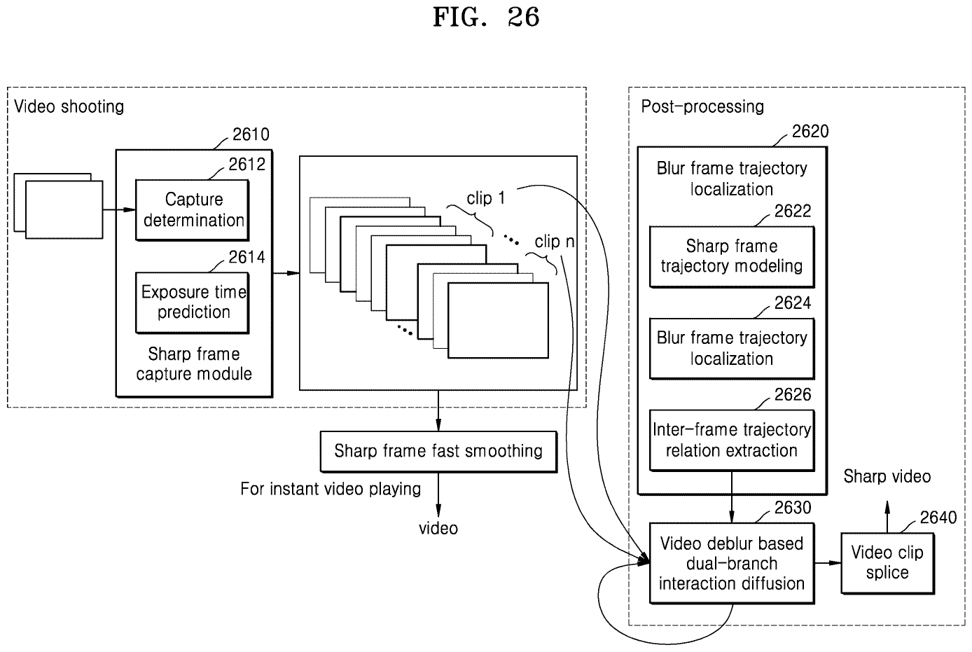

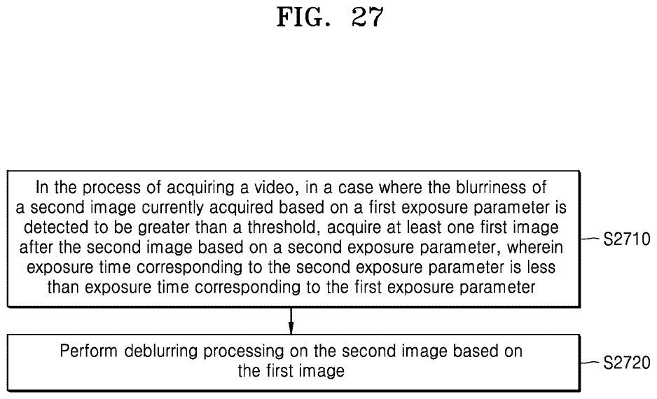

Based on at least one of the above embodiments, FIG. 27 illustrates a schematic diagram of a complete scheme for video deblurring according to an embodiment of the present disclosure. The scheme shown in FIG. 27 may be provided to address a problem that existing video deblurring methods are not applicable to large motion blur, and the longer the exposure time is, the more serious the motion blur is, and the scheme according to an embodiment of the present disclosure may remove the large motion blur in the video by actively capturing short exposure frames (e.g., sharp frames). The blurred video may be subsequently processed using the dual-branch module for video deblurring to obtain a sharp video. As shown in FIG. 26, this scheme may include a sharp frame capture module 2610, blur frame trajectory localization 2620, and video deblur based dual-branch interaction diffusion 2630, and a process may include the followings.

Sharp Frame Capture Module 2610: this module may be configured to determine whether there is blur in the current frame, and if the blur exceeds a set blur threshold, predict shooting exposure time, in order to shoot the short exposure frames (e.g., sharp frames) with clear texture using shorter exposure parameters. An example of the process may be based on the description of FIG. 4 and will not be repeated herein. The sharp frame capture module may include a capture determination module 2612 and an exposure time prediction module 2614. An example of the process may be based on the description of FIGS. 2 and 3 and will not be repeated herein. After the video shooting, a video sequence containing the short exposure frames (e.g., sharp frames) and the blur frames may be obtained and inputted into a post-processing module (including the blur frame trajectory localization and the video deblur based dual-branch interaction diffusion) for processing.

Blur Frame Trajectory Localization 2620: videos with large motion blur cannot predict accurate motion trajectories according to the blur images themselves. This module may set optimal motion trajectory points for the blur frames based on the motion trajectories of the sharp frames while ensuring the smoothness of the video. This module may include operations such as sharp frame trajectory modeling 2622, blur frame trajectory localization 2624, and inter-frame trajectory relation extraction 2626, as provided in the description of FIG. 14 and will not be repeated herein.

Video deblur based Dual-branch Interaction Diffusion 2630: this module may focus on different tasks, to perform deblurring processing on the blur frames and luminance enhancement on the sharp frames according to the motion descriptors of the output of the blur frame trajectory localization 2620, as provided in the description of FIG. 24 and will not be repeated herein. The inputs for this module may be a motion segment including a plurality of clips, each clip may include two short exposure frames and at least one blur frame in between, and the dual-branch interaction diffusion module may process one clip at a time, and then splice the clips together to finally obtain a clean video with consistent luminance and clear textures.

Optionally, if a user needs to watch a video instantly, the video may also be shot and then pass through a sharp frame fast smoothing module to replace the current sharp frames with an average of the front and back frames, so as to ensure that video luminance does not jump when the user watches the video instantly.

The video deblurring scheme provided in the embodiment of the present disclosure may enhance the visualization effect and solve the problem of serious blur caused by high-speed camera shake and/or object motion during exposure, and may restore the sharp frames from consecutive blur frames, thereby improving the visualization effect.

FIG. 27 is a schematic flowchart of another method performed by an electronic device according to an embodiment of the present disclosure. As shown in FIG. 27, the method may include the followings.

At step S2710, in the process of acquiring a video, in a case where the blurriness of a second image currently acquired based on a first exposure parameter is detected to be greater than a threshold, at least one first image after the second image may be acquired based on a second exposure parameter, wherein exposure time corresponding to the second exposure parameter is less than exposure time corresponding to the first exposure parameter.

In the embodiment of the present disclosure, the acquisition of the video may involve a motion scene, wherein the motion scene means that the shot subject is in motion, and/or an electronic device used for shooting is in motion, both of which may result in blurring of the shot video. A high-speed motion scene means that the shot subject or the electronic device used for shooting is moving at a faster speed, which may produce greater video blur.

In the embodiment of the present disclosure, the blurriness of the second image may be determined based on a blur map of the second image. Optionally, a blur estimation network may be pre-trained to compute a blur map of the second image. For example, features of the second image may be extracted using a convolutional layer to obtain convolutional features thereof. By using the convolutional layer to further extract features about the blur for the obtained convolutional features, the blur map of the second image in the X-axis and the Y-axis may be predicted, wherein the blur map represents the blurriness (value) and direction of each pixel in the third image.

In the embodiment of the present disclosure, the exposure parameters may include the exposure time or the like, but are not limited thereto.

The motion blur in a video may be generally due to long exposure time when being shot. Therefore, short exposure frames, e.g., sharp pictures captured with shorter exposure time, may be actively captured as the sharp frames.

Then, in the embodiments of the present disclosure, the second image may be an image with greater blur in the video, and for ease of understanding, the second image may be referred to as a blur frame hereinafter. The first image may be an image with less blur in the video, and for ease of understanding, the first image may be referred to as a sharp frame hereinafter. The blurriness of the video or image may be determined based on motion-generated artifact or trailing. For example, the blurriness may be associated with, but not limited to, the number of pixels covered by trailing.

In the embodiment of the present disclosure, the shooting of the video and the capturing of the short exposure frames may be performed using a same acquisition device (e.g., a video camera), and thus the short exposure frames may be a part of a video sequence, and shooting the short exposure frames may not change a frame rate of the video.

Optionally, the number of images acquired based on the second exposure parameter may be set by those skilled in the art according to an actual implementation, such as one frame, etc., and the embodiment of the present disclosure is not limited herein.

Optionally, it is determined, by a capture determination module in the process of acquiring the video, that whether there is blur in the current frame (shot based on the first exposure parameter), and if the blur exceeds a set blur threshold (the second threshold), the second exposure parameter may be used to shoot the short exposure frames (the sharp frames) with the clear textures using shorter shooting exposure time, as provided in the description of FIG. 2, and will not be repeated herein.

At step S2720, deblurring processing may be performed on the second image based on the first image.

In the embodiment of the present disclosure, the method of performing deblur processing on the second image based on the first image has been described in the above embodiment(s), and will not be repeated herein. Alternatively, other methods of performing deblur processing may also be used, and the embodiment of the present disclosure will not be limited herein.

In the embodiment of the present disclosure, the first exposure parameter may be an auto-exposure parameter computed by the electronic device.

In the embodiment of the present disclosure, the second exposure parameter may be a preset fixed value, those skilled in the art may set the value of the second exposure parameter according to an actual implementation, and the embodiment of the present disclosure is not limited herein.

Alternatively, in the embodiment of the present disclosure, the second exposure parameter may be computed in real time. Optionally, for example, before the at least one image after the second image is acquired based on the second exposure parameter, the second exposure parameter may be determined based on the second image and the first exposure parameter. Optionally, the process may be computed by a formula, or may be obtained by model prediction, or may be determined in other methods, and the embodiment of the present disclosure is not limited herein.

Optionally, the process may determine, based on the first exposure parameter Tᵤ of the current frame (t) and the second image-related information, the second exposure parameter Tₚ for shooting the short exposure frames such as the next frame (t+1). The second image-related information may include at least one of the second image, image features of the second image, the blurriness of the second image (e.g., a blur map), and a histogram of the second image, but is not limited thereto.

In the embodiment of the present disclosure, once it is determined to capture the sharp frames, an optional implementation may be provided for predicting the exposure parameters for shooting, where the optimal exposure parameters are required to balance luminance and sharpness. Specifically, the determining the second exposure parameter based on the second image and the first exposure parameter may include: determining a lower bound of the exposure time based on luminance of the second image and the first exposure parameter; determining an upper bound of the exposure time based on the first exposure parameter; determining an adjustment coefficient based on the blurriness of the second image, image features of the second image, the upper bound and the lower bound; and determining the second exposure parameter based on the first exposure parameter, the upper bound, the lower bound and the adjustment coefficient.

Details of example implementations and beneficial effects have been provided in the description of steps S210 to S240 and FIGS. 3 to 5, and will not be repeated herein. Alternatively, other methods may also be used, and the embodiment of the present disclosure will not be limited herein.

/In the embodiment of the present disclosure, an optional implementation may be provided for setting of the second threshold. Specifically, this threshold may be preset according to a threshold at which related art methods (e.g., attention mechanism, similarity or optical flow method, etc.) cannot effectively perform the video deblurring processing. For example, as can be seen in the example of FIG. 6, the blur map of different blurred images (e.g., sharp, mild, medium, heavy, etc., but not limited thereto, and other division criteria may also be used) may be computed and processed using the related art methods. The threshold may be set according to the smallest blur map value that cannot be processed by the related art methods, e.g., the medium blur and the heavy blur cannot be subjected to the video deblurring process using the related art methods, and a smaller blur value corresponding to the medium blur may be used as the second threshold.

The method performed by the electronic device provided in the embodiment of the present disclosure may shoot a sharp picture by actively capturing short exposure frames, which may be used to effectively remove large motion blur in a video, because the short exposure frames have clear textures.

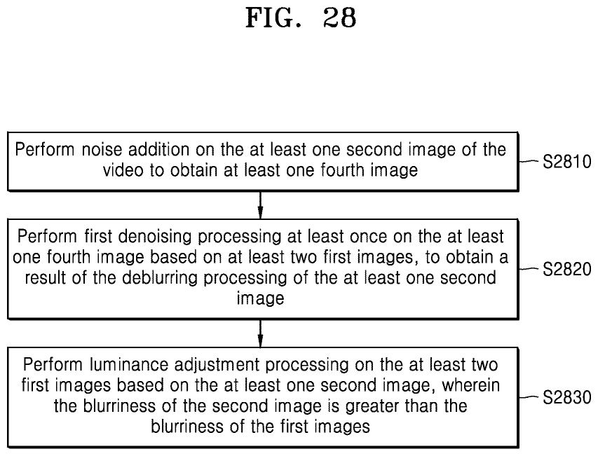

FIG. 28 is a schematic flowchart of yet another method performed by an electronic device according to an embodiment of the present disclosure. As shown in FIG. 28, the method may include the followings.

At step S2810, noise addition may be performed on the at least one second image of the video to obtain at least one fourth image.

In the embodiment of the present disclosure, the video may be recorded by a user in real time, selected by the user in a photo album, or received by the user from a network or other device, etc., and the embodiment of the present disclosure does not limit how the video is acquired.

In the embodiment of the present disclosure, the video may be obtained by directly recording various subjects such as characters, animals, plants, landscapes, buildings, objects, etc., and/or their movement processes, or the video may be obtained by synthesizing a plurality of video data and/or image data, and the embodiment of the present disclosure does not limit a content and a source of the video.

In the embodiment of the present disclosure, the video may include a sequence of consecutive image frames (which may also be referred to as frames, and in some embodiments may also be referred to as frame images or images), and the embodiment of present disclosure does not limit a number of image frames of the video.

In the embodiment of the present disclosure, a motion scene possibly included in the video may means that the shot subject is in motion, and/or an electronic device used for shooting is in motion, both of which may result in blurring of the shot video. A high-speed motion scene means that the shot subject or the electronic device used for shooting is moving at a faster speed, which may produce greater video blur.

In the embodiment of the present disclosure, the second image may refer to an image in the video with a greater blurriness, and for ease of understanding, the second image may be referred to as a blur frame hereinafter.

In the embodiment of the present disclosure, the blurriness of the video or image may be determined based on motion-generated artifact or trailing. For example, the blurriness may be associated with, but not limited to, the number of pixels covered by trailing.

At step S2820, first denoising processing may be performed at least once on the at least one fourth image based on at least two first images, to obtain a result of the deblurring processing of the at least one second image.

In the embodiment of the present disclosure, the first image may refer to an image in the video with smaller blurriness, and for ease of understanding, the first image may be referred to as a sharp frame hereinafter. The blurriness of the second image may be greater than the blurriness of the first images. The method of determining the first images and the second image has been provided in the description of any of the above embodiments, and will not be repeated herein. Alternatively, other methods may also be used, and the embodiment of the present disclosure will not be limited herein.

In the embodiment of the present disclosure, the deblurring processing may be performed on images based on a diffusion model, and the deblurring processing may make reference to texture information from the at least two first images, thereby obtaining a video with clear textures.

Details of example implementations and beneficial effects have been provided in the description of steps S1321 to S1322 and will not be repeated herein. Alternatively, other methods may also be used, and the embodiment of the present disclosure will not be limited herein.

At step S2830, luminance adjustment processing may be performed on the at least two first images based on the at least one second image.

In the embodiments of the present disclosure, the actively captured short exposure frames (e.g., sharp frames) may have rich textures but low luminance, and the blur frames have motion blur but have normal luminance, and luminance adjustment processing may be performed on the at least two first images based on the at least one second image.

Details of example implementations and beneficial effects have been provided in the description of steps S810 to S820 and will not be repeated herein. Alternatively, other methods may also be used, and the embodiment of the present disclosure will not be limited herein.

In the embodiment of the present disclosure, an optional implementation may be provided for the step S2820. Specifically, offset information and scale change information between images of a video may be determined based on the at least two first images, and first denoising processing may be performed at least once on the at least one fourth image based on the at least two first images, the offset information and the scale change information.

In the embodiment of the present disclosure, in order to enable subsequent deblurring model(s) to effectively utilize a relation between the images, a specific inter-frame motion relation (also referred to as inter-frame trajectory relation or motion descriptor) including the offset information (also referred to as offset descriptor) and the scale change information (also referred to as scale descriptor) may be extracted from the image as guidance information for the deblurring model(s).

Optionally, the offset information and the scale change information may be with respect to the predetermined first image, which has been described above and will not be repeated herein. Alternatively, the offset information and the scale change information may be between adjacent image frames.

In the embodiment of the present disclosure, the offset descriptor may be obtained by an offset relation of pixel points, e.g., pixel offset information of the X-axis and the Y-axis with respect to the predetermined first image. The scale descriptor may be determined by the convergence or divergence of trajectories, such as shown in FIGS. 12a and 12b.

The method of determining the offset information and the scale change information has been provided in the description of any of the above embodiments, such as FIGS. 8 to 14, etc., and will not be repeated herein. Alternatively, other methods may also be used, and the embodiment of the present disclosure will not be limited herein.

In the embodiment of the present disclosure, the offset information and the scale change information may be input into the diffusion model for deblurring processing, to make reference to texture information from the at least two first images, thereby obtaining a video with clear textures.

In the embodiment of the present disclosure, the performing first denoising processing on the at least one fourth image based on the at least two first images, the offset information and the scale change information, may include:
adjusting phase features of the at least one fourth image based on phase features of the at least two first images to obtain the updated phase features;
obtaining first guidance information based on the updated phase features and amplitude features of the at least one fourth image; and
performing the first denoising processing on the at least one fourth image based on the first guidance information, the offset information and the scale change information.

Details of example implementations and beneficial effects have been provided in the description of steps S310 to S330 and FIG. 15, and will not be repeated herein. Alternatively, other methods may also be used, and the embodiment of the present disclosure will not be limited herein.

In the embodiment of the present disclosure, the performing first denoising processing on the at least one fourth image based on the at least two first images, the offset information and the scale change information, may include:
clustering pixels in the at least one fourth image based on the offset information and the scale change information, to obtain a clustering result; and
processing the at least one fourth image using at least one concatenated attention network, based on the at least two first images and the clustering result.

Details of example implementations and beneficial effects have been provided in the description of steps S410 to S420 and FIG. 16a, and will not be repeated herein. Alternatively, other methods may also be used, and the embodiment of the present disclosure will not be limited herein.

In an optional implementation, the at least one concatenated attention network may include at least one self-attention network, and processing the at least one fourth image using the self-attention network may include:
performing, based on the clustering result, a first attention computation on pixels of the same type in at least one fifth image using the self-attention network to obtain a first attention result, wherein the at least one fifth image is obtained based on the at least one fourth image, or the at least one fifth image is obtained based on the at least one fourth image and the at least two first images; and
processing the at least one fourth image based on the first attention result.

The method of obtaining the fifth image may be seen in the description above and will not be repeated herein.

In an optional implementation, the at least one concatenated attention network may include at least one inter-frame attention network, and processing the at least one fourth image using the inter-frame attention network may include:
scaling the at least two first images based on the scale change information and the clustering result, and fusing the at least two scaled first images to obtain a sixth image;
performing a second attention computation on the sixth image and the at least one fourth image using the inter-frame attention network to obtain a second attention result; and
processing the at least one fourth image based on the second attention result.

In an optional implementation, the video may include at least one clip, each clip may include the at least two first images and the at least one second image, the at least one concatenated attention network may include at least one inter-clip attention network, and processing the at least one fourth image using the inter-clip attention network may include:
performing a third attention computation on the at least one first clip subjected to the deblurring processing and a second clip to be subjected to the deblurring processing using the inter-clip attention network, to obtain a third attention result; and
processing the at least one fourth image corresponding to the second flip based on the third attention result.

Details of example implementations and beneficial effects of the above several optional implementations have been provided in the description of at least one of steps S510˜S520, steps S610˜S630, steps S710˜S720, FIG. 7, FIGS. 16b˜16e, and FIGS. 17˜21, and will not be repeated herein. Alternatively, other methods may also be used, and the embodiment of the present disclosure will not be limited herein.

In the embodiment of the present disclosure, an optional implementation may be provided for the step S2830. Specifically, amplitude features of the at least two seventh images may be adjusted based on amplitude features of the at least one second image to obtain the updated amplitude features, second guidance information may be obtained based on the updated amplitude features and phase features of the at least two seventh images, and the luminance adjustment processing may be performed on the at least two first images based on the second guidance information.

Details of example implementations and beneficial effects have been provided in the description of steps S910 to S930 and FIG. 22, and will not be repeated herein. Alternatively, other methods may also be used, and the embodiment of the present disclosure will not be limited herein.

In the embodiment of the present disclosure, an example of performing the deblurring processing and the luminance adjustment processing as a dual-branch interaction has been provided in the description of FIGS. 23-24, and will not be repeated herein.

In the embodiment of the present disclosure, the processing of the dual-branch interaction diffusion model may be based on each motion segment in the video, the model inputs may be a motion descriptor and a motion segment in the video, the motion segment may include a plurality of clips, one clip self-attention network two sharp frames and one or more blur frames in between, the sharp frames may have rich textures, but low luminance, while the blur frames have motion blur, but normal luminance. The motion segment may be processed together, and the dual-branch module may process one clip each time and then splice the clips to output a sharp motion segment video. An example of the process may be based on the description of FIG. 25, and will not be repeated herein.

In the embodiment of the present disclosure, the deblurring processing and the luminance adjustment processing may be performed as a dual branch interaction, which may simultaneously realize the consistency of textures and luminance between the sharp frames and the blur frames.

In one example, the video deblurring scheme provided in the embodiment of the present disclosure may be applied to the following scene: when shooting a high-speed scene or the shooter is moving at high speed, the function of the present scheme may be started, and the video will be automatically deblurred after being stored in the gallery.

The technical solutions according to the embodiments of the present disclosure may be applied to various electronic devices (including the acquisition device) capable of shooting, including, but not limited to, mobile terminals, smart terminals, and the like, such as smartphones, tablets, laptops, smart wearable devices (e.g., watches, eyeglasses, etc.), smart speakers, in-vehicle terminals, personal digital assistants, portable multimedia players, navigation devices, and the like, but are not limited to these examples. It should be understood by those skilled in the art that, in addition to or alternatively to elements used especially for mobile purposes, the constructions according to the embodiments of the present disclosure may be applied to stationary types of terminals, such as digital televisions, desktop computers, and the like.

The technical solutions according to the embodiments of the present disclosure may be applied to video deblurring in a server, such as a stand-alone physical server, a server cluster or a distributed system composed of a plurality of physical servers, or a cloud server that provides basic cloud computing services such as a cloud service, a cloud database, a cloud computing, a cloud function, a cloud storage, a network service, a cloud communication, a middleware service, a domain name service, a security service, a content delivery network (CDN), and big data and artificial intelligence platforms.

Optionally, the video deblurring scheme provided by the embodiments of the present disclosure may also be accomplished collaboratively by a plurality of computing-capable electronic devices. For example, different electronic devices may each accomplish a portion of the steps of each method provided by the embodiments of the present disclosure. For example, the video shooting may be performed by one electronic device, the post-processing may be performed by another electronic device, and so on, but the present disclosure is not limited thereto.

According to the embodiments of the present disclosure, the video deblurring effects in high-speed scenes may be improved as compared to the prior art.

The embodiments of the present disclosure may provide an electronic device including a processor, and optionally further including a transceiver and/or a memory coupled with the processor, the processor being configured to perform the steps of the method according to any optional embodiment of the present disclosure.

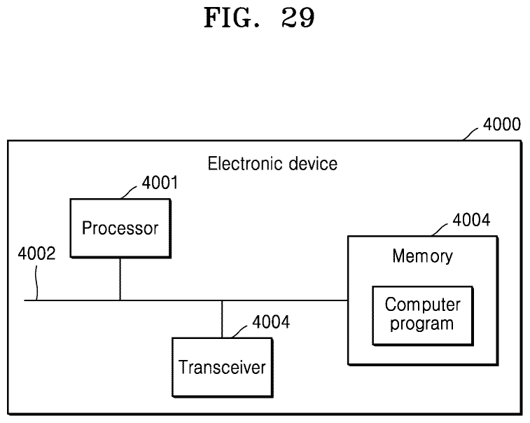

FIG. 29 shows a schematic structure diagram of an electronic device to which the embodiment of the present disclosure is applied. As shown in FIG. 29, the electronic device 4000 shown in FIG. 29 may include a processor 4001 and a memory 4003. The processor 4001 is connected to the memory 4003, for example, through a bus 4002. Optionally, the electronic device 4000 may further include a transceiver 4004 that may be used for data exchange, for example, transmission and/or reception of data, between the electronic device and other electronic device. It should be noted that, in practical applications, the number of transceiver 4004 is not limited to one, and the structure of the electronic device 4000 shown in FIG. 29 does not constitute any limitations to the embodiments of the present disclosure. Optionally, the electronic device may be a first network node, a second network node or a third network node.

The processor 4001 may be a central processing unit (CPU), a general-purpose processor, a digital signal processor (DSP), an application specific integrated circuit (ASIC), or a field programmable gate array (FPGA), or other programmable logic devices, transistor logic devices, hardware components, or any combination thereof. It may implement or execute various example logical blocks, modules and circuits described in connection with the present disclosure. The processor 4001 may also be a combination for realizing computing functions, for example, a combination of one or more microprocessors, a combination of a DSP and a microprocessor, etc.

The processor 4001 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The bus 4002 may include a path to transfer information between the components described above. The bus 4002 may be a peripheral component interconnect (PCI) bus, or an extended industry standard architecture (EISA) bus, etc. The bus 4002 may be an address bus, a data bus, a control bus, etc. For ease of presentation, the bus is represented by only one thick line in FIG. 29. However, it does not mean that there is only one bus or one type of buses.

The memory 4003 may be one or more of read only memories (ROMs) or other types of static storage devices that may store static information and instructions, random access memories (RAMs) or other types of dynamic storage devices that may store information and instructions, may be electrically erasable programmable read only memories (EEPROMs), compact disc read only memories (CD-ROMs) or other optical disk storages, optical disc storages (including compact discs, laser discs, discs, digital versatile discs, blue-ray discs, etc.), magnetic storage media or other magnetic storage devices, or any other medium capable of carrying or storing computer programs and capable of being read by a computer, without limitation.

The memory 4003 may be used to store computer program for executing the embodiment of the present disclosure, and may be controlled by the processor 4001. The processor 4001 may be used to execute the computer program stored in the memory 4003 to implement the steps provided in any method embodiment described above.

Embodiments of the present disclosure may provide a computer-readable storage medium having a computer program stored on the computer-readable storage medium, the computer program, when executed by a processor, performing the steps and corresponding contents of the foregoing method embodiments.

Embodiments of the present disclosure also provide a computer program product including a computer program, the computer program when executed by a processor performing the steps and corresponding contents of the preceding method embodiments.

The method performed by the electronic device, the electronic device, the storage medium and the program product according to the embodiments of the present disclosure may determine a first motion trajectory of pixels between at least two first images of a video; determine motion trajectory points corresponding to at least one second image of the video based on the first motion trajectory, and obtain a second motion trajectory based on the motion trajectory points, a blurriness of the at least one second image being greater than a blurriness of the at least two first images; and perform a deblurring processing on the at least one second image based on the second motion trajectory. That is, the embodiments of the present disclosure may set more accurate motion trajectory points for the second image based on the first motion trajectory, to overcome the problem that the video cannot predict an accurate motion trajectory based on the second image itself in a motion scene, and may guarantee that based on the second motion trajectory, a better deblurring effect of the video may be obtained in the motion scene.

According to an embodiment of the disclosure, a method of processing a video, the method being performed by an electronic device may be provided. The method may include determining a first motion trajectory of pixels between at least two first images of the video. The method may include determining motion trajectory points corresponding to at least one second image of the video based on the first motion trajectory. The method may include obtaining a second motion trajectory based on the motion trajectory points, a blurriness of the at least one second image being greater than a blurriness of each of the at least two first images. The method may include performing a deblurring processing on the at least one second image based on the second motion trajectory.

According to an embodiment of the disclosure, the method may include, based on a determination that a blurriness of a third image acquired based on a first exposure parameter is greater than a threshold, acquiring, as the at least two first images, at least one image after the third image based on a second exposure parameter. An exposure time corresponding to the second exposure parameter may be less than an exposure time corresponding to the first exposure parameter.

According to an embodiment of the disclosure, the method may include determining the second exposure parameter based on the third image and the first exposure parameter.

According to an embodiment of the disclosure, the method may include determining a lower bound of the exposure time based on a luminance of the third image and the first exposure parameter. The method may include determining an upper bound of the exposure time based on the first exposure parameter. The method may include determining an adjustment coefficient based on the blurriness of the third image, image features of the third image, the upper bound and the lower bound. The method may include determining the second exposure parameter based on the first exposure parameter, the upper bound, the lower bound and the adjustment coefficient.

According to an embodiment of the disclosure, the method may include determining an offset of each of the at least two first images from a defined first image. The method may include determining the first motion trajectory based on the offset.

According to an embodiment of the disclosure, the method may include inserting the motion trajectory points corresponding to the at least one second image into the first motion trajectory. The method may include adjusting positions of the inserted motion trajectory points in the first motion trajectory based on the blurriness and a blur direction of the at least one second image. The method may include obtaining the second motion trajectory based on motion trajectory points having the adjusted positions.

According to an embodiment of the disclosure, the method may include determining offset information and scale change information between images of the video based on the second motion trajectory. The method may include performing the deblurring processing on the at least one second image based on the offset information and the scale change information.

According to an embodiment of the disclosure, the method may include performing a noise addition on the at least one second image to obtain at least one fourth image. The method may include performing a first denoising processing at least once on the at least one fourth image based on the at least two first images, the offset information and the scale change information, to obtain a result of the deblurring processing of the at least one second image.

According to an embodiment of the disclosure, the method may include adjusting phase features of the at least one fourth image based on phase features of the at least two first images to obtain updated phase features. The method may include obtaining first guidance information based on the updated phase features and amplitude features of the at least one fourth image. The method may include performing the first denoising processing on the at least one fourth image based on the first guidance information, the offset information and the scale change information.

According to an embodiment of the disclosure, the method may include clustering pixels in the at least one fourth image based on the offset information and the scale change information, to obtain a clustering result. The method may include processing the at least one fourth image using at least one concatenated attention network, based on the at least two first images and the clustering result.

According to an embodiment of the disclosure, the at least one concatenated attention network may comprise at least one self-attention network. The method may include performing, based on the clustering result, a first attention computation on pixels of a same type in at least one fifth image using the at least one self-attention network to obtain a first attention result. The at least one fifth image may be obtained based on the at least one fourth image, or the at least one fifth image may be obtained based on the at least one fourth image and the at least two first images. The method may include processing the at least one fourth image based on the first attention result.

According to an embodiment of the disclosure, the at least one concatenated attention network may comprise at least one inter-frame attention network. The method may include scaling the at least two first images based on the scale change information and the clustering result. The method may include fusing the at least two scaled first images to obtain a sixth image. The method may include performing a second attention computation on the sixth image and the at least one fourth image using the at least one inter-frame attention network to obtain a second attention result. The method may include processing the at least one fourth image based on the second attention result.

According to an embodiment of the disclosure, the video may comprise at least one clip. Each clip may comprise the at least two first images and the at least one second image. The at least one concatenated attention network may comprise at least one inter-clip attention network. The method may include performing a third attention computation on at least one first clip subjected to the deblurring processing and a second clip to be subjected to the deblurring processing using the at least one inter-clip attention network, to obtain a third attention result. The method may include processing the at least one fourth image corresponding to the second clip based on the third attention result.

According to an embodiment of the disclosure, the method may include performing a luminance adjustment processing on the at least two first images based on the at least one second image.

According to an embodiment of the disclosure, the method may include adjusting amplitude features of at least two seventh images based on amplitude features of the at least one second image to obtain updated amplitude features, the at least two seventh images being obtained by performing a noise addition on the at least two first images. The method may include obtaining second guidance information based on the updated amplitude features and phase features of the at least two seventh images. The method may include performing the luminance adjustment processing on the at least two first images based on the second guidance information.

According to an embodiment of the disclosure, an electronic device may be provided. The electronic device may include at least one processor including processing circuitry, and memory comprising one or more storage media storing instructions that, when executed by the at least one processor individually or collectively. The instructions when executed by the at least one processor individually or collectively, cause the electronic device to determine a first motion trajectory of pixels between at least two first images of a video. The instructions when executed by the at least one processor individually or collectively, cause the electronic device to determine motion trajectory points corresponding to at least one second image of the video based on the first motion trajectory. The instructions when executed by the at least one processor individually or collectively, cause the electronic device to obtain a second motion trajectory based on the motion trajectory points, a blurriness of the at least one second image being greater than a blurriness of each of the at least two first images. The instructions when executed by the at least one processor individually or collectively, cause the electronic device to perform a deblurring processing on the at least one second image based on the second motion trajectory.

According to an embodiment of the disclosure, the instructions when executed by the at least one processor individually or collectively, cause the electronic device tom, based on a determination that a blurriness of a third image acquired based on a first exposure parameter is greater than a threshold, acquire, as the at least two first images, at least one image after the third image based on a second exposure parameter, wherein an exposure time corresponding to the second exposure parameter is less than an exposure time corresponding to the first exposure parameter.

According to an embodiment of the disclosure, the instructions when executed by the at least one processor individually or collectively, cause the electronic device to determine an offset of each of the at least two first images from a defined first image. The instructions when executed by the at least one processor individually or collectively, cause the electronic device to determine the first motion trajectory based on the offset.

According to an embodiment of the disclosure, the instructions when executed by the at least one processor individually or collectively, cause the electronic device to insert the motion trajectory points corresponding to the at least one second image into the first motion trajectory. The instructions when executed by the at least one processor individually or collectively, cause the electronic device to adjust positions of the inserted motion trajectory points in the first motion trajectory based on the blurriness and a blur direction of the at least one second image. The instructions when executed by the at least one processor individually or collectively, cause the electronic device to obtain the second motion trajectory based on motion trajectory points having the adjusted positions.

According to an embodiment of the disclosure, a non-transitory computer-readable medium storing one or more instructions may be provided. The one or more instructions, when executed by at least one processor, may cause the at least one processor of an electronic device to perform operation corresponding to the method.

According to a further aspect of the embodiments of the present disclosure, there is provided a computer-readable storage medium having a computer program stored thereon, that when executed by a processor, implements the method performed by the electronic device according to the embodiments of the present disclosure.

According to a further aspect of the embodiments of the present disclosure, there is provided a computer program product including a computer program, that when executed by a processor, implements the method performed by the electronic device according to the embodiments of the present disclosure.

A method of processing a video performed by an electronic device, the electronic device, a storage medium and a program product are provided. The method includes: determining a first motion trajectory of pixels between at least two first images of a video; determining motion trajectory points corresponding to at least one second image of the video in the first motion trajectory, and obtaining a second motion trajectory based on the motion trajectory points, a blurriness of the at least one second image being greater than a blurriness of each of the at least two first images; and performing a deblurring processing on the at least one second image based on the second motion trajectory. A better deblurring effect of the video may be obtained in a motion scene. Optionally, the above method performed by the electronic device may be performed using an artificial intelligence model.

The terms “first”, “second”, “third”, “fourth”, “1”, “2”, etc. (if present) in the specification and claims of the present disclosure and the accompanying drawings above are used to distinguish similar objects and need not be used to describe a particular order or sequence. It should be understood that the data so used is interchangeable where appropriate such that embodiments of the present disclosure described herein may be implemented in an order other than that illustrated or described in the text.

It should be understood that while the flow diagrams of embodiments of the present disclosure indicate the individual operational steps by arrows, the order in which these steps are performed is not limited to the order indicated by the arrows. Unless explicitly stated herein, in some implementation scenarios of embodiments of the present disclosure, the implementation steps in the respective flowcharts may be performed in other orders as desired. In addition, some, or all of the steps in each flowchart may include multiple sub-steps or multiple phases based on the actual implementation scenario. Some or all of these sub-steps or stages may be executed at the same moment, and each of these sub-steps or stages may also be executed at different moments separately. The order of execution of these sub-steps or stages may be flexibly configured according to requirements in different scenarios of execution time, and the embodiments of the present disclosure are not limited thereto.

The above-mentioned description and the drawings are provided merely as examples to help readers to understand the present disclosure, and they should not be interpreted or aim to limit the scope of the present disclosure in any way. Although some embodiments are provided, based on what is disclosed herein, it will be apparent to those skilled in the art that the embodiments and examples shown may be altered without departing from the scope of the present disclosure. Employing other similar means of implementation based on the technical ideas of the present disclosure also fall within the scope of protection of embodiments of the present disclosure.

What is claimed is:

1. A method of processing a video, the method being performed by an electronic device, comprising:
determining a first motion trajectory of pixels between at least two first images of the video;
determining motion trajectory points corresponding to at least one second image of the video based on the first motion trajectory;
obtaining a second motion trajectory based on the motion trajectory points, a blurriness of the at least one second image being greater than a blurriness of each of the at least two first images; and
performing a deblurring processing on the at least one second image based on the second motion trajectory.

2. The method of claim 1, further comprising:
based on a determination that a blurriness of a third image acquired based on a first exposure parameter is greater than a threshold, acquiring, as the at least two first images, at least one image after the third image based on a second exposure parameter, wherein an exposure time corresponding to the second exposure parameter is less than an exposure time corresponding to the first exposure parameter.

3. The method of claim 2, further comprising, prior to acquiring, as the at least two first images, the at least one image after the third image:
determining the second exposure parameter based on the third image and the first exposure parameter.

4. The method of claim 3, wherein the determining the second exposure parameter comprises:
determining a lower bound of the exposure time based on a luminance of the third image and the first exposure parameter;
determining an upper bound of the exposure time based on the first exposure parameter;
determining an adjustment coefficient based on the blurriness of the third image, image features of the third image, the upper bound and the lower bound; and
determining the second exposure parameter based on the first exposure parameter, the upper bound, the lower bound and the adjustment coefficient.

5. The method of claim 1, wherein the determining the first motion trajectory comprises:
determining an offset of each of the at least two first images from a defined first image; and
determining the first motion trajectory based on the offset.

6. The method of claim 1, wherein the determining the motion trajectory points comprises:
inserting the motion trajectory points corresponding to the at least one second image into the first motion trajectory;
adjusting positions of the inserted motion trajectory points in the first motion trajectory based on the blurriness and a blur direction of the at least one second image; and
obtaining the second motion trajectory based on motion trajectory points having the adjusted positions.

7. The method of claim 1, wherein the performing the deblurring processing comprises:
determining offset information and scale change information between images of the video based on the second motion trajectory; and
performing the deblurring processing on the at least one second image based on the offset information and the scale change information.

8. The method of claim 7, wherein the performing the deblurring processing on the at least one second image based on the offset information and the scale change information, comprises:
performing a noise addition on the at least one second image to obtain at least one fourth image; and
performing a first denoising processing at least once on the at least one fourth image based on the at least two first images, the offset information and the scale change information, to obtain a result of the deblurring processing of the at least one second image.

9. The method of claim 8, wherein the performing the first denoising processing comprises:
adjusting phase features of the at least one fourth image based on phase features of the at least two first images to obtain updated phase features;
obtaining first guidance information based on the updated phase features and amplitude features of the at least one fourth image; and
performing the first denoising processing on the at least one fourth image based on the first guidance information, the offset information and the scale change information.

10. The method of claim 8, wherein the performing the first denoising processing comprises:
clustering pixels in the at least one fourth image based on the offset information and the scale change information, to obtain a clustering result; and
processing the at least one fourth image using at least one concatenated attention network, based on the at least two first images and the clustering result.

11. The method of claim 10, wherein the at least one concatenated attention network comprises at least one self-attention network, and
processing the at least one fourth image using the at least one self-attention network comprises:
performing, based on the clustering result, a first attention computation on pixels of a same type in at least one fifth image using the at least one self-attention network to obtain a first attention result, wherein the at least one fifth image is obtained based on the at least one fourth image, or the at least one fifth image is obtained based on the at least one fourth image and the at least two first images; and
processing the at least one fourth image based on the first attention result.

12. The method of claim 10, wherein the at least one concatenated attention network comprises at least one inter-frame attention network, and processing the at least one fourth image using the at least one inter-frame attention network comprises:
scaling the at least two first images based on the scale change information and the clustering result;
fusing the at least two scaled first images to obtain a sixth image;
performing a second attention computation on the sixth image and the at least one fourth image using the at least one inter-frame attention network to obtain a second attention result; and
processing the at least one fourth image based on the second attention result.

13. The method of claim 10, wherein the video comprises at least one clip, each clip comprises the at least two first images and the at least one second image,
wherein the at least one concatenated attention network comprises at least one inter-clip attention network, and
wherein the processing the at least one fourth image using the at least one inter-clip attention network comprises:
performing a third attention computation on at least one first clip subjected to the deblurring processing and a second clip to be subjected to the deblurring processing using the at least one inter-clip attention network, to obtain a third attention result; and
processing the at least one fourth image corresponding to the second clip based on the third attention result.

14. The method of claim 1, further comprising:
performing a luminance adjustment processing on the at least two first images based on the at least one second image.

15. The method of claim 14, wherein the performing the luminance adjustment processing comprises:
adjusting amplitude features of at least two seventh images based on amplitude features of the at least one second image to obtain updated amplitude features, the at least two seventh images being obtained by performing a noise addition on the at least two first images;
obtaining second guidance information based on the updated amplitude features and phase features of the at least two seventh images; and
performing the luminance adjustment processing on the at least two first images based on the second guidance information.

16. An electronic device comprising:
at least one processor including processing circuitry, and
memory comprising one or more storage media storing one or more instructions that, when executed by the at least one processor individually or collectively, cause the electronic device to:
determine a first motion trajectory of pixels between at least two first images of a video;
determine motion trajectory points corresponding to at least one second image of the video based on the first motion trajectory;
obtain a second motion trajectory based on the motion trajectory points, a blurriness of the at least one second image being greater than a blurriness of each of the at least two first images; and
perform a deblurring processing on the at least one second image based on the second motion trajectory.

17. The electronic device of claim 16,
wherein the one or more instructions, when executed by the at least one processor individually or collectively, cause the electronic device to:
based on a determination that a blurriness of a third image acquired based on a first exposure parameter is greater than a threshold, acquire, as the at least two first images, at least one image after the third image based on a second exposure parameter, wherein an exposure time corresponding to the second exposure parameter is less than an exposure time corresponding to the first exposure parameter.

18. The electronic device of claim 16,
wherein the one or more instructions, when executed by the at least one processor individually or collectively, cause the electronic device to:
determine an offset of each of the at least two first images from a defined first image; and
determine the first motion trajectory based on the offset.

19. The electronic device of claim 16,
wherein the one or more instructions, when executed by the at least one processor individually or collectively, cause the electronic device to:
insert the motion trajectory points corresponding to the at least one second image into the first motion trajectory;
adjust positions of the inserted motion trajectory points in the first motion trajectory based on the blurriness and a blur direction of the at least one second image; and
obtain the second motion trajectory based on motion trajectory points having the adjusted positions.

20. A non-transitory computer-readable medium storing one or more instructions, wherein the one or more instructions, when executed by at least one processor individually or collectively, cause the at least one processor of an electronic device to:
determine a first motion trajectory of pixels between at least two first images of a video;
determine motion trajectory points corresponding to at least one second image of the video based on the first motion trajectory;
obtain a second motion trajectory based on the motion trajectory points, a blurriness of the at least one second image being greater than a blurriness of each of the at least two first images; and
perform a deblurring processing on the at least one second image based on the second motion trajectory.
